(19) United States
(12) Patent Application Publication
(10) Pub. No.: US 2022/0208405 A1
(43) Pub. Date: Jun. 30, 2022

(54) HIGH LEVEL WASTE TRANSPORT SYSTEM WITH CONTAINMENT FEATURE

(71) Applicant: Henry Crichlow, Norman, OK (US)

(72) Inventor: Henry Crichlow, Norman, OK (US)

(21) Appl. No.: 17/185,751

(22) Filed: Feb. 25, 2021

Related U.S. Application Data
(60) Provisional application No. 63/131,686, filed on Dec. 29, 2020.

(51) Int. Cl. G21F 5/14; G21F 5/08; G21F 5/12; B32B 1/08

(52) U.S. Cl. CPC G21F 5/14; G21F 5/08; B32B 2439/40; B32B 1/08; B32B 2307/54; G21F 5/12

(57) ABSTRACT

Reusable transporters for removable housing of radioactive materials and configured for safely containing the radioactive materials during transportation operations of the transporters are described. A given transporter may have at least four layers, an outermost structural-jacket, an innermost liner, a containment layer, and a radiation shielding layer. The structural-jacket is made from strong materials like steel and/or titanium, but not stainless steel. The containment layer and/or the radiation shielding layer may have one or more sub-layers. The containment layer is stretchable and designed to completely enclose the internally stored radioactive materials even in the event of a serious impact event to the overall transporter. The radioactive materials are removably stored within an inner cavity of the transporter, within the liner. The inner cavity may be accessible from at least one terminal end of the transporter. The at least one terminal end is removably closeable via use of closure means.

### PRIORITY NOTICE

The present application claims priority under 35 U.S.C. § 119(e) to U.S. Provisional Patent Application Ser. No. 63/131,686 filed on Dec. 29, 2020, the disclosure of which is incorporated herein by reference in its entirety.

### TECHNICAL FIELD OF THE INVENTION

The present invention relates in general to the transport of radioactive materials and more specifically to apparatus, devices, components, systems, and methods for transporting radioactive materials that provide for containment of waste materials that could otherwise be leaked or discharged by accidents or otherwise during transportation.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

This invention generally relates to an apparatus (e.g., a transporter) for transporting radioactive material(s) and is specifically concerned with an engineered comparatively light-weight container apparatus (e.g., the transporter) having high strength structural walls, integrated radiation shielding/absorbing means, an integral means for waste containment in the event of an accident (e.g., a containment layer), and a design that optimizes the amount of radioactive material(s) within a given weight limit while meeting required limitations for highway and/or rail transport.

At least one purpose of such transporters may be to transport radioactive wastes in as safe a manner as possible between at least two different sites, using highways and/or rails. Transporters, for example, may be used to transport radioactive material(s), spent nuclear fuel (SNF) assemblies (subassemblies), high-level waste (HLW), high-level vitrified waste cannisters, and/or combinations of radioactive waste of various types to different sites.

While the transportation casks of the prior art are generally capable of safely transporting wastes such as SNF assemblies, in the event of no serious impact scenario, it has been observed that there is considerable room for improvement, in the structural design, in cask weight optimization, and in safety features of the current casks themselves. So much of the weight of the prior art casks is dedicated to its massive structural feature that only a small amount of loading of actual waste is possible, because highway load limits restrict the total weight of the cask-truck combination unless the transport operation is specially permitted, which may be expensive and with uncertain approval outcomes.

Today (circa 2021) there is an enormous quantity of nuclear waste accumulating across the world; and that may need to safely transported from one location to another location. In the U.S. alone there are more than 90,000 metric tons (MT) of high-level solid (radioactive) waste (HLW) being stored in cooling pools and in concrete casks on the Earth's (terrestrial) surface. This surface storage is intended to be temporary and is very costly typically costing hundreds of millions of dollars annually. The HLW is generally called spent nuclear fuel (SNF) and consists of thousands of nuclear fuel assemblies which have been removed from operating nuclear power plants. There is also a relatively small amount of weapons-grade plutonium (WGP) from the non-operational nuclear weapons programs.

These SNF assemblies, HLW, and/or WGP components are highly radioactive and also thermally active and continue to generate sensible heat which must be safely removed by maintaining these assemblies in cooling tanks at the onsite surface storage sites. There are approximately 80,000 individual fuel assemblies being stored today in the U.S. and about 1,200 MT being added annually.

The prior art focuses on the surface storage and transportation of the SNF assemblies. In general, the current systems use a set of cylindrical shaped casks, horizontally or vertically aligned, that may be commissioned and licensed for storage, transport, or both. These casks are designed to protect the environment and to date, very little has been designed into them to allow rapid deployment, transportation, or to improve efficiencies in the overall SNF disposal process.

Today, the SNF casks are heavy, weighing up to 250,000 lbs. The prior art casks are cumbersome to manage and move, both due to their weight and due to their size. The prior art casks need massive cranes with more than 125 Ton capacity at each end of the transport chain when the casks are moved to another location. The prior art casks are expensive costing upwards of $6,000,000 per prior art cask to construct and to transport. The prior art casks have limited capacity, with less than twenty-four (24) SNF assemblies per cask. There are stringent requirements for cask licensing/permitting that may or may not be indicative of the behavior of the cask system in real world catastrophic situations. Some published licensing tests such as “dropping the cask test” seem to be designed for real world situations, however, in a true situation the full extent of the damage to the cask may not be captured during the published test. In other words, the test does not go far enough to cover the full range of real-world possibilities to could occur while transporting a given cask of radioactive materials. Only one cask per tractor trailer is normally used for SNF transport because of the size and weight of a single prior art cask.

A further aspect of the prior art is the cask system business model. Currently, companies in the storage and transport areas focus on managing revenues by selling the expensive casks at multi-million-dollar rates, charging fees for transport, also charging millions of dollars annually to store the casks on the surface behind a wire fence on a concrete or gravel pad. In one recent case, in the northeast U.S., storage charges of $264,000,000 USD for forty-three (43) casks on the surface was achieved. Transport operations require specially permitted massive rail or tractor-trailer transport systems to move the SNF between the originating sources and destinations of the SNF. None of the elements present in the business model provide for a long-term solution to the SNF disposal problem. This business model is unsustainable and undesirable.

There is a significant and long-felt, but currently unmet, need for new devices, apparatuses, systems, mechanisms, means, methods, and business models that transport SNF assemblies (and/or portions thereof) in a manner that is both far cheaper and far safer. To solve the above-described problems, the present invention provides new transporters, devices, apparatuses, systems, mechanisms, means, methods, and business models that transport SNF assemblies (and/or portions thereof) in a manner that is both far cheaper and far safer.

It shall be shown, that the new transporters, devices, apparatuses, systems, mechanisms, means, methods, and business models taught herein, has an integrated container mechanism (e.g., containment layer) such that any contained radioactive materials that might potentially be expelled, ejected, leaked, and/or extruded from internally located waste-capsule(s) (that hold the radioactive material(s) within an inner cavity of a given transporter) during transit for any reason (e.g., a severe impact event) may remain safely enclosed and trapped within the body of the containment layer; and thus, protecting the external environment from harm.

It is to these ends that the present invention has been developed.

### BRIEF SUMMARY OF THE INVENTION

To minimize the limitations in the prior art, and to minimize other limitations that will be apparent upon reading and understanding the present specification, the present invention may describe reusable transporters for removable housing of radioactive materials, wherein the transporters may be configured for safely containing the radioactive materials during transportation operations of the transporters. Transportation operations may be from a terrestrial surface storage location of radioactive materials (that was originally intended as a non-final repository location) to a final repository storage location. In some embodiments, a given transporter may comprise at least four layers, namely, (1) an outermost structural-jacket, (2) an innermost liner, (3) a containment layer, and (3) a radiation shielding layer. In some embodiments, the (outermost) structural-jacket may be made from strong materials like steel, titanium, and/or the like; but, not stainless steel. In some embodiments, the containment layer and/or the radiation shielding layer may have one or more sub-layers. In some embodiments, the containment layer may be stretchable, deformable, and/or compliant; and designed to completely enclose the internally stored radioactive materials even in the event of a serious impact event to the overall transporter. In some embodiments, the radioactive materials are removably stored within an inner cavity of the transporter, within the (innermost) liner. In some embodiments, the inner cavity may be accessible from at least one terminal end of the transporter. In some embodiments, the at least one terminal end is removably closeable via use of closure means. In some embodiments, at least portions and/or components of the closure means may be components of the (outermost) structural jacket (e.g., a cover) and/or the containment layer (e.g., end-caps).

Embodiments of the present invention may concerned with the transport of hazardous and/or nuclear waste/material(s) and, more specifically, to methods and systems of utilizing a special transport apparatus (e.g., the transporters) capable of transporting encapsulated SNF assemblies (or the like) in the transporters; such that, in the event of an accident or occurrence of a negative event, the SNF material is contained and remains inside the transporter safely with no spillage to the ecosphere or ambient environment. It is contemplated in these embodiments, that the SNF assemblies (and/or subassemblies) are assembled in a separate operational process and are then collected and prepared for transport and transported using the transporters illustrated herein.

In some embodiments, a given transporter may comprise a cylindrical body with multilayers and an innermost internal cavity capable of holding the prepackaged SNF waste-capsule(s). In some embodiments, the cylindrical body may enclose an innermost cavity, configured to receive at least one prepackaged waste-capsule, with the cylindrical body having at least closeable/openable terminal end. In some embodiments, the multilayers of the transporter may comprise a discrete, cylindrically-enclosed containment layer of a durable, flexible, ductile, pliable, impervious, and/or shock absorbing material, with closed or closeable terminal ends. In some embodiments, the multilayers of the transporter may comprise a protective or shielding zone which may comprise cylindrical gamma and/or neutron radiation protective layer(s), with closed or closeable terminal ends. In some embodiments, the protective or shielding zone(s)/layer(s) may comprise a combination of several available material systems for shielding and radiation protection. In some embodiments, the multilayers of the transporter may comprise a cylindrical neutron absorption layer, with closed or closeable terminal ends.

In some embodiments, the multilayers of the transporter may comprise a cylindrical gamma protection layer, with closed or closeable terminal ends. In some embodiments, the multilayers of the transporter may comprise a cylindrical internally supportive layer (e.g., a liner) on which the inserted waste-capsule(s) may rest and/or reside inside the transporter, with closed or closeable terminal ends.

In some embodiments, the transporter may be translocated via tractor-trailer highway means. In some embodiments, the transporter may be relocated via railway means. In some embodiments, the transporter may be relocated via barge, ship, boat, vessel, or water borne means. In some embodiments, several co-packaged transporters may be relocated on a single mobile transport system via tractor-trailer highway means, rail, water means, and/or by heavy-lift transport aircraft in an emergency. In some embodiments, several co-packaged transporters may be grouped together forming a multipack on a single or multiple reinforced mobile transport system via tractor-trailer highway means, rail, water means, and/or the like.

In some embodiments, the transporter may contain a single prepackaged waste-capsule or in other cases, the transporter may contain a plurality of prepackaged waste-capsules. Note, each such waste-capsule may contain the radioactive material(s).

In some embodiments, a method may provide for fabricating at least one transporter. In some embodiments, a method may provide for fabricating at least one transporter system with a containment feature. In some embodiments, a method may provide for transporting transporter(s).

Some embodiments, may specifically address technical considerations, such as, but not limited to: during the transport of SNF assemblies by road, rail or water, the transporter (or portion thereof) may be damaged in transit, possibly during an accident event. In all potential damage situations (e.g., an impact event), leakage of radioactive material(s) may be avoided by the containment layer of flexible, ductile, break-resistant material behaving like a containment shroud, that entirely surrounds and contains the waste-capsule(s) (with the radioactive material(s)) located within the containment layer; even if the waste-capsule itself and/or the outermost structural jacket is damaged; e.g., on/by impact. Containment of the radioactive material(s) may depend in part on the physical and structural properties of the multilayered transporter as described further below.

It is an objective of the present invention to provide transporters that are configured to transport radioactive material(s), such as, but not limited to, SNF assemblies (and/or portions thereof, HLW, WGP parts/components, portions thereof, combinations thereof, and/or the like.

It is another objective of the present invention to provide such transporters that are configured to transport a variety of radioactive material(s) in various/different waste forms, such as, but not limited to, SNF assemblies (and/or portions thereof, HLW, WGP parts/components, portions thereof, combinations thereof, and/or the like.

It is another objective of the present invention to provide such transporters that are configured to transport the radioactive material(s) in manner that is much more affordable (cheaper) than for transporting prior art casks.

It is another objective of the present invention to provide such transporters that are configured to transport the radioactive material(s) in manner that is safe to human health and to environment external to the transporters.

It is another objective of the present invention to provide such transporters that are configured to transport the radioactive material(s) in manner that meets applicable regulatory guidelines, including transportation guidelines.

It is another objective of the present invention to provide such transporters that are configured to transport the radioactive material(s) in manner that generally meets public acceptance.

It is another objective of the present invention to provide such transporters that are configured to transport the radioactive material(s), wherein the transporters are more durable than prior art casks.

It is another objective of the present invention to provide such transporters that are configured to transport the radioactive material(s), wherein the transporters (when filled) weigh considerably less than prior art casks.

It is another objective of the present invention to provide such transporters that are configured to transport the radioactive material(s), wherein the transporters may accommodate relatively large amounts of radioactive waste.

It is another objective of the present invention to provide such transporters that are configured to transport the radioactive material(s), wherein implementing such transporters requires minimal infrastructure and/or accessory upgrades (e.g., existing SNF assemblies/subassemblies, shipping containers, truck trailers, and/or railcars may be utilized with the transporters).

It is another objective of the present invention to provide such transporters that are configured to transport the radioactive material(s), wherein implementation of such transporters may be readily scaled up, as needed/desired.

It is another objective of the present invention to provide such transporters that are configured to transport the radioactive material(s), wherein the transporters have radiation shielding/absorption element(s), layers, and/or aspects.

It is another objective of the present invention to provide such transporters that are configured to transport the radioactive material(s), wherein the transporters have an external/outermost structural-jacket layer that is strong, robust, and rigid, but comparatively light-weight as compared to prior art casks.

It is another objective of the present invention to provide such transporters that are configured to transport the radioactive material(s), wherein the transporters have an innermost cavity configured to receive at least one waste-capsule, wherein the waste-capsule may contain the radioactive waste, such as, but not limited to, in a SNF assembly and/or subassembly form.

It is another objective of the present invention to provide such transporters that are configured to transport the radioactive material(s), wherein the transporters have a containment layer that is configured to stretch and/or deform, but to remain intact, in the event of an impact, that completely surrounds and protects the internally housed radioactive waste material(s) (that may be within waste-capsules).

It is another objective of the present invention to provide impact limiters that may be removably attached to the transporters to further protect the transporters from impacts.

It is another objective of the present invention to provide such transporters that are configured to transport the radioactive material(s), wherein the transporters are configured for loading into shipping containers, for loading onto truck trailers, and/or for loading into/onto railcars.

It is yet another objective of the present invention to provide such transporters that are reusable; that is, the once a given transporter reaches a given destination its internally loaded waste-capsule(s) may be removed and that now empty transporter may be reused with other waste-capsule(s).

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements. Furthermore, in some instances some common items are left off of the drawings for clarity and ease of viewing. For example, in some instances bolts on flanges may not be shown in a given view but it may be obvious to a person of ordinary skill in the relevant arts (technical fields) from the description, that these items may be present in the given embodiment. In some cases, one or more adhesive layers may not be shown but are described in the below text since the thin layer may not be easily visible in a drawing, figure, and/or graphic.

FIG. 1A is prior art and illustrates an example of a Canadian commercial spent nuclear fuel (SNF) assembly.

FIG. 1B is prior art and illustrates an example of a Russian commercial SNF assembly.

FIG. 1C is prior art and illustrates an example of a United States (U.S.) commercial SNF assembly.

FIG. 2A illustrates an overview of a prior art technology for transporting SNF.

FIG. 2B illustrates an overview of another prior art technology for transporting SNF.

FIG. 3 illustrates a lengthwise cross-sectional diagram of a given waste-capsule (pre-packaged capsule) containing one or more SNFs and/or portions thereof.

FIG. 4A illustrates a lengthwise cross-sectional diagram of a given transporter containing one or more waste-capsules (prepackaged capsules).

FIG. 4B illustrates a lengthwise cross-sectional diagram of a given transporter containing one or more waste-capsules (prepackaged capsules).

FIG. 5A illustrates a transverse width cross-sectional diagram of a given transporter containing one or more waste-capsules (prepackaged capsules).

FIG. 5B illustrates a transverse width cross-sectional diagram of a given transporter containing one or more waste-capsules (prepackaged capsules).

FIG. 5C illustrates a transverse width cross-sectional diagram of a given transporter containing one or more waste-capsules (prepackaged capsules).

FIG. 5D illustrates a transverse width cross-sectional diagram of a given transporter containing one or more waste-capsules (prepackaged capsules).

FIG. 6A illustrates a partial exploded view of a given transporter from a center most waste-capsule (prepackaged capsule) to an exterior of the given transporter.

FIG. 6B illustrates a partial exploded view of a given transporter from a center most waste-capsule (prepackaged capsule) to an exterior of the given transporter.

FIG. 6C illustrates a partial exploded view of a given transporter from a center most waste-capsule (prepackaged capsule) to an exterior of the given transporter.

FIG. 6D illustrates a partial exploded view of a given transporter from a center most waste-capsule (prepackaged capsule) to an exterior of the given transporter.

FIG. 7 illustrates a lengthwise cross-sectional diagram of a given transporter containing at least one waste-capsule (prepackaged capsule).

FIG. 8A illustrates a partial lengthwise cross-sectional diagram of a given transporter containing at least one waste-capsule (prepackaged capsule), with a focus on one end of the given transporter, showing the opening, loading, and/or closure end of the given transporter, with a bolt on flange cover.

FIG. 8B illustrates a partial lengthwise cross-sectional diagram of a given transporter containing at least one waste-capsule (prepackaged capsule), with a focus on one end of the given transporter, showing the opening, loading, and/or closure end of the given transporter, with a screw on threaded flange cover.

FIG. 8C illustrates a partial lengthwise cross-sectional diagram of a given transporter containing at least one waste-capsule (prepackaged capsule), with a focus on one end of the given transporter, showing the opening, loading, and/or closure end of the given transporter, with a wedge type end cap.

FIG. 9A illustrates an example of machinery and/or equipment for executing a crush test on a given transporter.

FIG. 9B illustrates an external crushed section of a given transporter.

FIG. 9C illustrates a cutaway example of a crushed transporter showing internally, an unbroken but crushed waste-capsule (prepackaged capsule) (which would hold SNF) inside the crushed transporter.

FIG. 10A illustrates at least one impact limiter attached to an end of a given transporter.

FIG. 10B illustrates a cross-section of an impact limiter that has received an end of a given transporter.

FIG. 10C illustrates a cross-section of an impact limiter with an attachment band.

FIG. 11A illustrates a multi-pack example of packing a plurality of transporters on a transportation vehicle platform.

FIG. 11B illustrates a multi-pack example of packing a plurality of transporters on a transportation vehicle platform.

FIG. 12 illustrates at least some steps in a method of transporting radioactive and/or nuclear waste materials (e.g., SNF) using waste-capsules (prepackaged capsules) and transporters.

### REFERENCE NUMERAL SCHEDULE

100 SNF assembly 100
100a Canadian SNF assembly 100a
100b Russian SNF assembly 100b
100c United States SNF assembly 100c
200 prior art horizontal cask 200
201 prior art transport system outer shell 201
203 prior art transport system neutron absorber 203
205 prior art transport system gamma shield 205
207 prior art transport system impact limiter 207
209 lid 209
221 prior art vertical cask 221
223 prior art vertical transport external protection 223
225 prior art vertical transport system top end cap 225
227 prior art vertical transport system base cap 227
300 waste-capsule (prepackaged capsule) 300
301 shell (wall) 301
303 separator 303
305 internal support 305
307 end cap (end plug) 307
400 transporter 400
401 transporter layers 401
403 internal support 403
405 separator 405
407 cavity 407
601 liner 601
603 radiation shield 603
605 gamma radiation shield 605
607 neutron radiation shield 607
609 containment layer 609
611 structural jacket (of transporter) 611
613 adhesive (between jacket and containment layer) 613
615 embedded magnetic strip 615
617 shield layer 617
690 centerline of transporter (center axis) 690
695 outside zone of transporter 695
699 inside zone of transporter 699
701 cap 701
703 radiation protective media plate 703
705 end support plate 705
709 cover 709
711 screw type end cap 711
809 flange type cover 809
811 flange bolts 811
813 threads 813
815 screw type cover 815
817 threaded connection 817
819 wedge type end cap 819
901 commercial LaBounty Shear machine (or the like) 901
903 crushed section of transporter shell 903
999 approximate size of an adult human 999
1001 omnidirectional impact limiter 1001
1003 omnidirectional impact limiter shell (wall) 1003
1005 omnidirectional impact limiter absorber material 1005
1007 omnidirectional impact limiter connector band 1007
1009 portion of transporter extends within impact limiter 1009
1011 impact limiter external lip 1011
1013 impact limiter pneumatic bladder 1013
1101 shipping container type trailer system 1101
1103 shipping container 1103
1105 structural support element 1105
1107 protective radiation shield 1107
1109 trailer transport system 1109
1200 method of transporting HLW/SNL 1200
1201 step of forming prepackaged capsule (with SNL) 1201
1203 step of collecting prepackaged capsule(s) 1203
1205 step of selecting prepackaged capsule packing mode 1205
1207 step of inserting prepackaged capsule(s) into transporter 1207
1209 step of sealing transporter(s) and adding impact limiters 1209
1211 step of loading transporter(s) onto transport vehicle 1211
1213 step of transporting to repository site 1213
1215 step of unloading prepackaged capsule(s) from transporter(s) 1215
1217 step of making now empty transporters available 1217

### DETAILED DESCRIPTION OF THE INVENTION

In this patent application, “HLW” (high-level waste) and “SNF” (spent nuclear fuel) may be used interchangeably to describe the radioactive waste/material.

In general, terminology used herein, particularly terminology associated/attached to a given reference numeral, may be intended to be descriptive, with the terminology naming used herein to suggest purpose, function, structure, and/or relationships.

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized and changes may be made without departing from the scope of the invention.

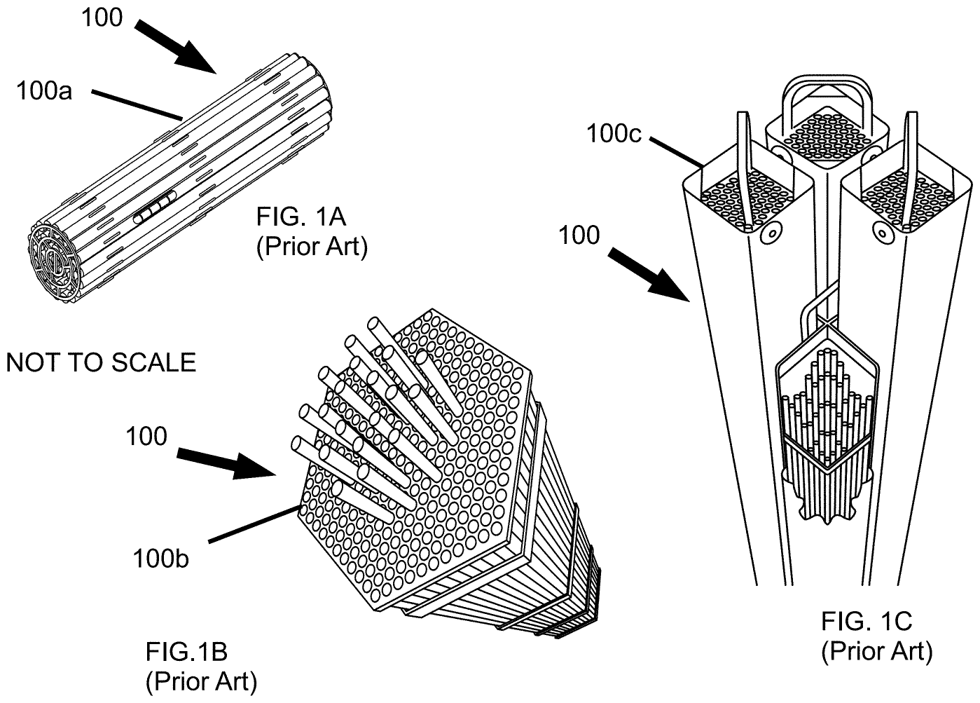

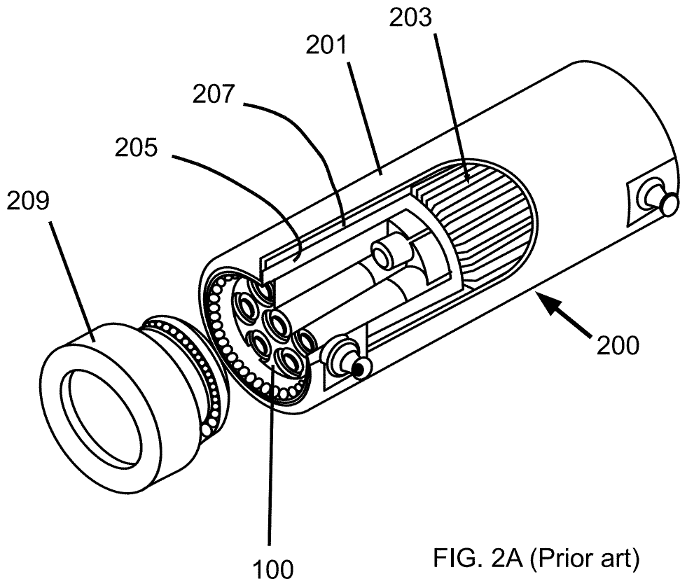

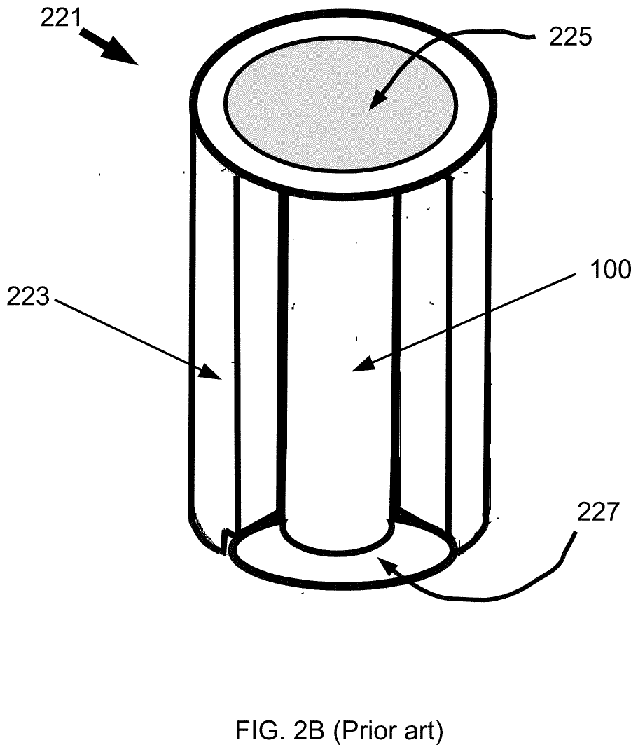

In general, the reference numeral scheme used herein is intended to correlate to particular figures. For example, “1XX” series reference numerals may be found in FIG. 1A, FIG. 1B, and/or FIG. 1C; “2XX” series reference numerals may be found in FIG. 2A and/or FIG. 2B; and so on.

FIG. 1A, FIG. 1B, and FIG. 1C collectively illustrate types of prior art nuclear fuel assemblies and/or spend nuclear fuel (SNF) assemblies 100, 100a, 100b, 100c currently used in/at many nuclear power plant(s). Reference numeral 100 may refer to any such SNF (or portion thereof). Reference numeral 100a may refer to a SNF (or portion thereof) typical of Canada; reference numeral 100b may refer to a SNF (or portion thereof) typical of Russia; and reference numeral 100c may refer to a SNF (or portion thereof) typical of the United States (U.S.). These nuclear fuel assemblies 100a, 100b, and 100c have been specifically designed to optimize performance during power generation. These nuclear fuel assemblies 100a, 100b, and 100c may vary in size and shape in actual practice, but generally have fixed, finite, and known dimensions, characteristics, and/or properties. Dimensions and geometries of nuclear fuel assemblies 100a, 100b, and 100c are precisely known and predetermined. In general practice today, the nuclear fuel assemblies 100a, 100b, and 100c are respectively, circular, hexagonal, or square in cross-section. Some nominal dimensions of these types of nuclear fuel rod assemblies 100c and 100a may be as follows: (a) square or rectilinear types are usually between four (4) meters (m) to five (5) m in length and about fourteen (14) centimeters (cm) to twenty two (22) cm in transverse width; and (b) nominal dimensions of the cylindrical fuel rod assemblies are about fifty (50) cm long and about ten (10) cm in transverse width.

During and after use, nuclear fuel assemblies 100a, 100b, and 100c may contain high-level waste (HLW), spend nuclear fuel (SNF), nuclear waste, radioactive waste, and/or the like. In some embodiments, at least one objective of the present invention may be to transport nuclear fuel assemblies 100a, 100b, and 100c (and/or portions thereof) that may have HLW, SNF, nuclear waste, radioactive waste, and/or the like into waste-capsule(s) 300 (prepackaged capsule(s) 300); wherein during transportation the one or more prepackaged capsule(s) 300 (with the waste) may reside within one or more transporters 400. In some embodiments, when a given prepackaged capsule(s) 300 (with the waste) reaches a repository location/destination, the given prepackaged capsule(s) 300 (with the waste) may then be placed (located) into well-bore(s) within deep-geological-formation(s) for final disposal.

Note, nuclear fuel assembly 100a, 100b, and 100c as used herein may also refer to a portion of an entire/intact nuclear fuel assembly. For example, and without limiting the scope of the present invention, portions of an entire nuclear fuel assembly 100a, 100b, and 100c may be required to be cut/disassembled into smaller portions for insertion into a given waste-capsule 1300. Note, in such instances, the cutting and/or disassembly may be done without breaching a given fuel rod with HLW and/or SNF.

FIG. 2A may show a perspective and partial cutaway view of a prior art commercial capsule carrier in the prior art designated herein as “cask 200” for transporting complete SNF assemblies 100 (with HLW and/or SNF) during (terrestrial) transport operations, such as from nuclear power plant to and/or from surface-storage-locations. Surface transport of a given cask 200 could be transported via rail and/or truck. In some embodiments, a given cask 200 may be designed for and/or configured for: protecting its cargo (e.g., the complete SNF assembly 100) from shock (e.g., kinetic impacts); protecting the public from radiation exposure; protecting the environment from radiation exposure; and maintaining the integrity of the complete SNF assembly 100 stored within the given cask 200.

Continuing discussing FIG. 2A, a given cask 200 is a rigid elongate member configured for housing a complete SNF assembly 100. A given cask 200 is a cylindrical member configured for housing a complete SNF assembly 100. An exterior of cask 200 is outer shell 201. Outer shell 201 is a cylindrical and/or elongate shape. Outer shell 201 provides structural support of cask 200. In some embodiments, outer shell 201 is constructed of: steel, carbon steel, stainless steel, or steel alloys.

Continuing discussing FIG. 2A, a given cask 200 has heat conductors 203 (neutron absorber 203). The heat conductors 203 are configured to transport heat from SNF assembly 100 and out of the given cask 200. Disposed inside of an outer shell 201 of a given cask 200 are neutron shielding elements 203. The neutron shielding elements 203 provide for some radiation protection by providing for a means to absorb neutrons and/or slow down neutrons. The given neutron shielding elements 203 are a cylindrical sheath and surround the nuclear/radioactive SNF assembly 100.

Continuing discussing FIG. 2A, gamma shielding elements 205 are located exterior to SNF assembly 100. In some embodiments, the gamma shielding elements 205 provide for some radiation protection by providing for a means for absorbing gamma emissions. The gamma shielding elements 205 are cylindrical sheaths and surround the nuclear/radioactive material.

Continuing discussing FIG. 2A, a given cask 200 has an impact limiter 207.

Continuing discussing FIG. 2A, a given cask 200 has an end plug 209. The end plug 209 is located on a terminal end of cask 200. The end plug 209 is attached to a terminal end of cask 200. A given end plug 209 provides some shock absorption (kinetic energy absorption, e.g., from impacts/collisions).

FIG. 2B shows a perspective and partial cutaway view of a prior art commercial capsule carrier designated herein as “cask 221” for transporting completed SNF assemblies 100 (with HLW and/or SNF) during (terrestrial) transport operations, such as from nuclear power plant to and/or from surface-storage-locations. Surface transport of a given cask 221 could be transported via rail and/or truck.

Continuing discussing FIG. 2B, a given cask 221 is a rigid elongate, thick-walled member configured for housing a SNF assembly 100. A given cask 221 is a cylindrical member configured for housing SNF assembly 100. An exterior of cask 221 is outer shell 223. Outer shell 223 provides structural support of cask 221. Outer shell 223 is constructed from: steel, carbon steel, stainless steel, or steel alloys.

A given cask 221 has heat conductors and ventilators for air circulation (not shown). The heat conductors transport some heat from the SNF assembly 100 and out of the given cask 221. The ventilators circulate air through the given cask 221.

Disposed inside of outer shell 223 of a given cask 221 is neutron shielding elements (not shown). The neutron shielding elements provide for some radiation protection by providing for a means to absorb neutrons and/or slow down neutrons. Neutron shielding elements are a cylindrical sheath and surround the nuclear/radioactive material SNF assembly 100.

Disposed inside of the outer shell 223 of a given cask 221 are gamma shielding elements (not shown). The gamma shielding elements are located exterior to SNF assembly 100. The gamma shielding elements provide for some radiation protection by providing for a means for absorbing gamma emissions. Gamma shielding elements are cylindrical sheaths and surround the nuclear/radioactive material SNF assembly 100.

Continuing discussing FIG. 2B, a given cask 221 has a top end plug 225. The top end plug 225 is located on a top terminal end of cask 221. The top end plug 225 is attached to a top terminal end of cask 221.

Continuing discussing FIG. 2B, a given cask 221 has a bottom end plug 227. The bottom end plug 225 is located on a bottom terminal end of cask 221. The bottom end plug 225 is attached to a bottom terminal end of cask 221.

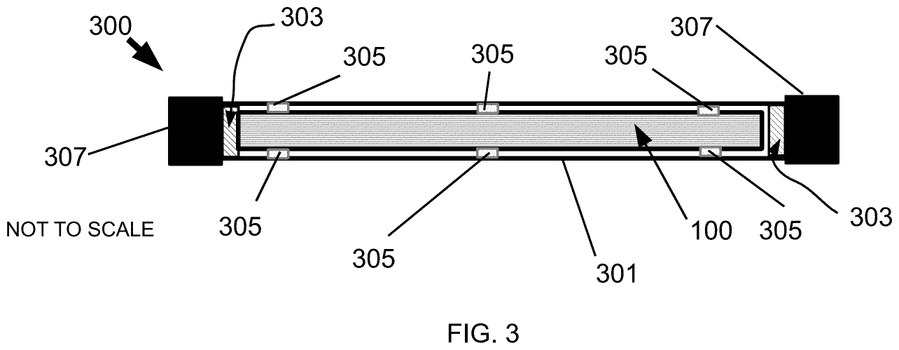

FIG. 3 illustrates a lengthwise cross-sectional diagram of a given prepackaged capsule 300 containing one or more SNFs 100 and/or portions thereof. As used herein, reference numeral “300” refers to capsules specifically configured to safely receive one or more SNFs 100 and/or portions thereof; and further as used herein, reference numeral “300” is associated with terms of “prepackaged capsule(s) 300” and/or “waste-capsule(s) 300.” “Prepackaged capsule(s) 300” and “waste-capsule(s) 300” may be used interchangeably herein. In some embodiments, prepackaged capsule(s) 300 and/or waste-capsule(s) 300 may comprise one or more SNFs 100 and/or portions thereof. In some embodiments, waste-capsule 300 may be prepackaged by a cooperating third party; and/or delivered to/or made available for transportation to a final disposal repository.

Continuing discussing FIG. 3, in some embodiments, waste-capsule 300 may be a generally to a substantially cylindrical body with an outer structural shell 301 supporting the SNF assembly 100 internally. In some embodiments, a given waste-capsule 300 may comprise: shell 301 (wall 301), separators 303, internal supports 305, end caps 307, portions thereof, combinations thereof, and/or the like. In some embodiments, separators 303 (end plugs 303) may be located on either terminal end of SNF assembly 100 within a given waste-capsule 300. In some embodiments, both terminal ends of a given SNF assembly 100 within a given waste-capsule 300 may be capped with separators 303. In some embodiments, separators 303 may protect and separate given SNF assembly 100 from the ends of the given waste-capsule 300. In some embodiments, separators 303 may be constructed of composite metal foams or similar lightweight but structurally competent material. In some embodiments, a plurality (series) of internal supports 305 may provide a “stand-off” from the internally housed SNF 100 to an interior of wall 301 of waste-capsule 300. In some embodiments, between the interior of wall 301 and the exterior of internally housed SNF 100, aside from internal supports 305, may be a gap, i.e., a region of void space. In some embodiments, end caps 307 may bound a given internally housed SNF 100 located within a given waste-capsule 300. In some embodiments, end caps 307 may bound a pair of separators 303 that have a given internally housed SNF 100 located between those disposed pair of separators 303. In some embodiments, end caps 307 may protect between consecutive waste-capsules 300 loaded into a given transporter 400.

Continuing discussing FIG. 3, in some embodiments, these types of prepackaged waste-capsules 300 may vary in length from under ten (10) feet to more than twenty (20) feet, plus or minus (+/−) one foot, depending on the types of SNF assembly 100 core used to construct and/or load the waste-capsules 300. In some embodiments, such specific lengths of waste-capsule 300 may easily fit on and be managed by routine loading equipment in use today.

Note, the waste-capsules 300 and/or portions thereof shown in the remaining figures do house one or more SNF assemblies 100 (and/or portions thereof). That is, the waste-capsules 300 and/or portions thereof shown in the remaining figures do contain: HLW, SNF, radioactive waste, radioactive materials, portions thereof, combinations thereof, and/or the like.

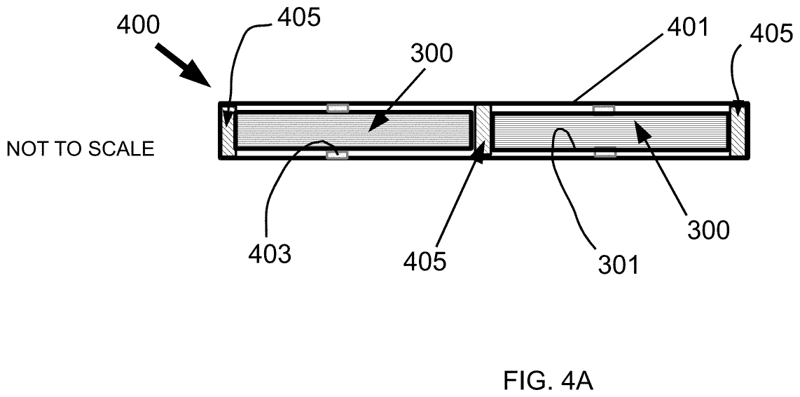

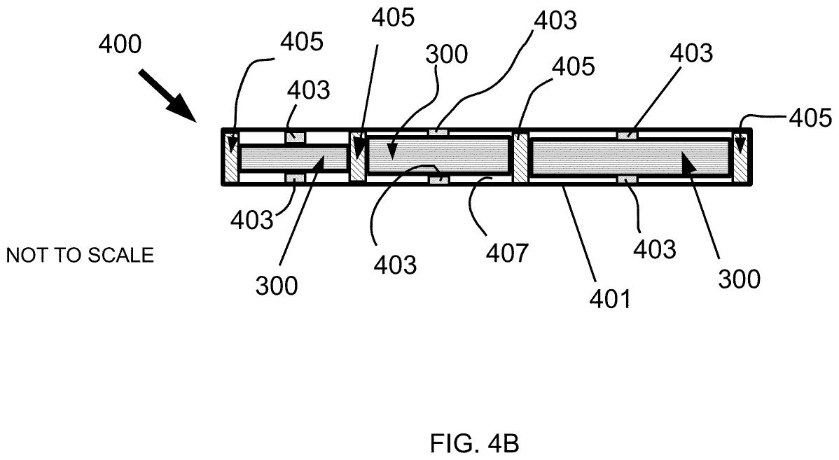

FIG. 4A illustrates a lengthwise cross-sectional diagram of a given transporter 400 containing at least two waste-capsules 300 (prepackaged capsules 300). In some embodiments, a given transporter 400 may be configured for removably housing radioactive material (e.g., within a given waste-capsule 300) and configured for safely containing the removably housed radioactive material during transportation operations of the given transporter 400. In some embodiments, a given transporter 400 may be configured for removably housing at least one waste-capsule 300 (with radioactive material(s)) configured for safely containing the removably housed at least one waste-capsule 300 during transportation operations of the given transporter 400. In some embodiments, at least two of these waste-capsules 300 may be arranged end to end, longitudinally, within the given transporter 400. In some embodiments, these at least two waste-capsules 300 may be of the same or of different sizes/dimensions. In some embodiments, two or more waste-capsules 300 may be packed within a given transporter 400 to maximize loading efficiency/capacity. In some embodiments, a given transporter 400 may be configured to removably house one or more waste-capsules 300. In some embodiments, a given transporter 400 may be configured to removably house at least one capsule 300. In some embodiments, a given transporter 400 may be configured to have one or more waste-capsules 300 loaded into that given transporter 400 and to then subsequently have those formerly loaded one or more waste-capsules 300 removed from that given transporter 400. In some embodiments, a given transporter 400 may be configured to have at least one waste-capsule 300 loaded into that given transporter 400 and to then subsequently have that formerly loaded at least one waste-capsule 300 removed from that given transporter 400. In some embodiments, when one or more waste-capsules 300 may be residing within a given transporter 400, those one or more waste-capsules 300 may be in a state ready for (surface) transportation. In some embodiments, when at least one waste-capsule 300 may be residing within a given transporter 400, that at least one waste-capsule 300 may be in a state ready for (surface) transportation.

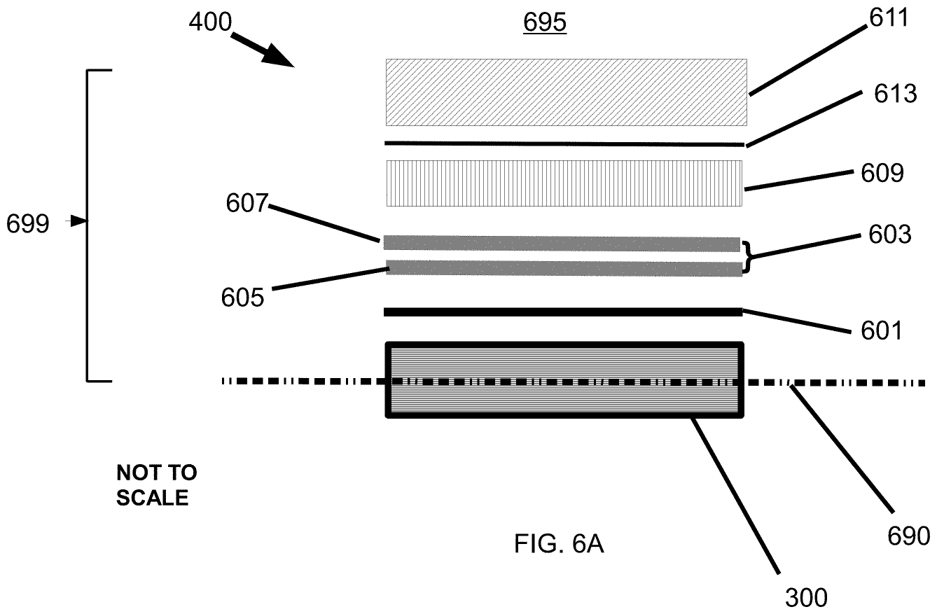

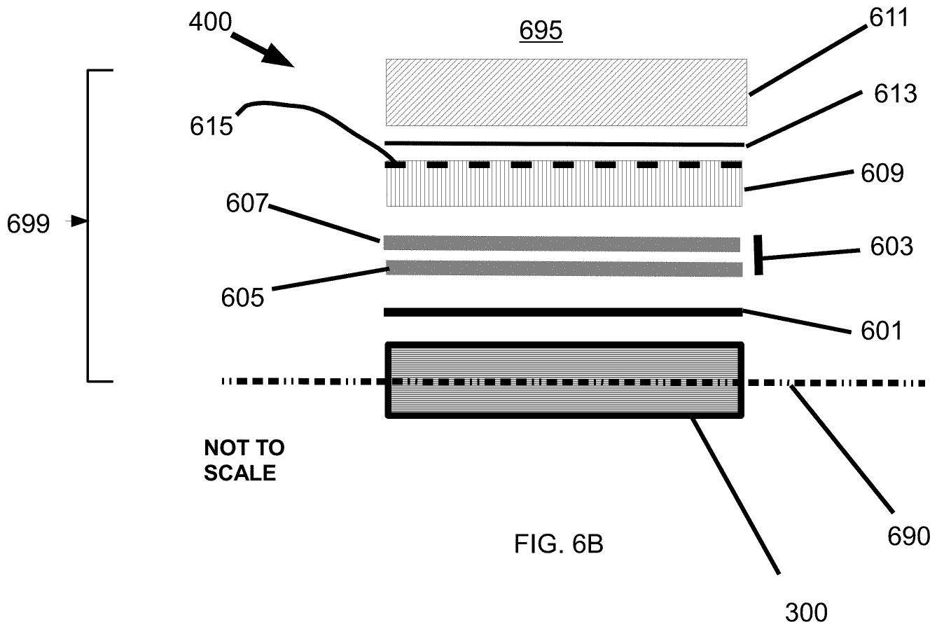

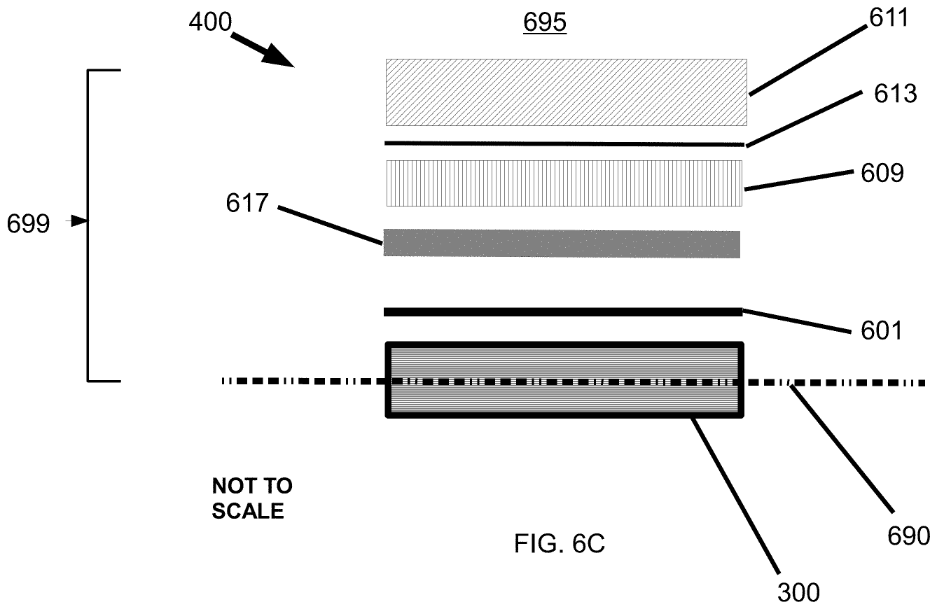

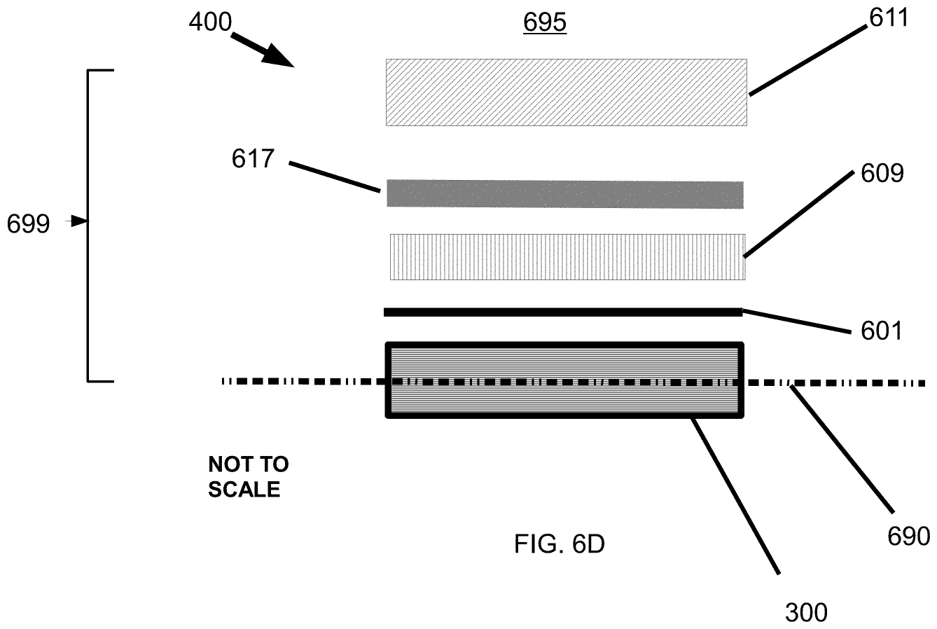

Continuing discussing FIG. 4A, in some embodiments, a given transporter 400 may comprise: transporter layers 401, internal supports 403, separators 405, cavities 407, portions thereof, combinations thereof, and/or the like. In some embodiments, transporter layers 401 may comprise one or more of: liner 601, radiation shield 603, gamma radiation shield 605, neutron radiation shield 607, containment layer 609, structural jacket 611 (shell/wall 611), adhesive(s) 613, magnet(s) 615, shield layer 617, portions thereof, combinations thereof, and/or the like. Note, these 6xx series reference numerals are shown in figures FIG. 6A to FIG. 6D and the written discussions thereof.

Continuing discussing FIG. 4A, in some embodiments, a given transporter 400 may at least four layers, namely, (1) an outermost structural jacket 611, (2) an innermost liner 601, (3) a containment layer 609, and (4) a radiation shielding layer 603. In some embodiments, these at least four layers may be collectively represented by transporter layers 401 in FIG. 4A and in FIG. 4B. In some embodiments, radiation shielding layer 603 may be configured to absorb at least some radiation emitted from the radioactive material when the radioactive material may be removably within an inner cavity 407 of the transporter 400. In some embodiments, a given transporter 400 may be a linearly elongate member with two opposing terminal ends and with a center axis 690 that may be centered with respect to a transverse-width cross-section of the given transporter 400 and wherein the center axis 690 may run in a direction that is parallel with an overall length of the transporter 400. (See e.g., FIG. 6A for center axis 690.) In some embodiments, with respect to these at least four layers, the innermost liner 601 may be closest to the center axis 690 and the outermost structural jacket 611 may be furthest away from the center axis 690. In some embodiments, containment layer 609 and radiation shielding layer 603 may (each) be disposed between outermost structural jacket 611 and innermost liner 601 (see e.g., FIG. 6A through FIG. 6D). In some embodiments, the innermost layer 601 may entirely surround the inner cavity 407. In some embodiments, the inner cavity 407 may be configured to removably receive the radioactive material(s). In some embodiments, the inner cavity 407 may be configured to removably receive the at least one waste-capsule 300 (wherein the at least one waste-capsule 300 may contain the radioactive material(s)). In some embodiments, the inner cavity 601 may be accessible from at least one terminal end selected from two opposing terminal ends of the given transporter 400. In some embodiments, the at least one terminal end (of the given transporter 400) may be removably closeable via use of closure means.

In some embodiments, the closure means may be how the at least one terminal end (of the given transporter 400) may be removably closed and/or opened. In some embodiments, the closure means may be how access is gained to inner cavity 407. In some embodiments, a given transporter 400 may comprise the closure means. In some embodiments, the closure means may comprise at least: a cover 709 (which may be cover 809 or cover 815), an end cap (which may be end cap 711 or end cap 819), an end support plate 705, and a radiation protective media plate 703. In some embodiments, the closure means may comprise at least one of: cover 709 (which may be cover 809 or cover 815), an end cap (which may be end cap 711 or end cap 819), end support plate 705, radiation protective media plate 703, portions thereof, combinations thereof, and/or the like.

In some embodiments, these at least four layers may be arranged substantially concentrically about the center axis 690. In some embodiments, the radioactive material(s) that may be removably housed within the inner cavity 407 may be selected from at least one spent nuclear fuel assembly 100 or portion thereof. In some embodiments, the radioactive material(s) may be loaded and sealed into at least one waste-capsule 300 and that at least one waste-capsule 300 may be removably loaded into the inner cavity 407 from the at least one terminal end of the given transporter 400, when the closure means is open.

Continuing discussing FIG. 4A, in some embodiments, disposed between an exterior surface of a given waste-capsule 300 (i.e., an exterior of shell 301) and an internal surface of 401 (i.e., an internal surface of liner 601) may be a plurality of internal supports 403. In some embodiments, this plurality of internal supports 403 may function as standoffs, providing for a gap, a region of void space, designated as cavity 407, that may be located between the exterior surface of the given waste-capsule 300 (i.e., the exterior of shell 301) and the internal surface of transporter layers 401 (i.e., the internal surface of liner 601). In some embodiments, a plurality of internal supports 403 make waste-capsule(s) 300 standoff from walls 601 of the transport cavity 407. In some embodiments, these internal supports 403 may maintain the waste-capsule(s) 300 in a fixed position during travel/transportation. In some embodiments, these internal supports 403 may be discarded when the waste-capsule 300 is being unloaded at the storage site or when the waste-capsules 300 are being loaded into the wellbores for disposal in the waste repository.

Continuing discussing FIG. 4A, in some embodiments, a given separator 405 may separate two waste-capsules 300 within a given transporter 400, with respect to a longitudinal (lengthwise) direction of the given transporter 400. In some embodiments, separator 405 may either be separators separating sequential waste-capsule 300 elements and/or end plugs 405 implemented at a terminal end of the given waste-capsule 300 cylinder. In some embodiments, separators 405 provide a buffer between sequential waste-capsules 300 (with respect to the longitudinal direction). In some embodiments, a terminal end of a given transporter 400 may have a separator 405. In some embodiments, a separator 405 may be located at a terminal end of a given transporter 400. In some embodiments, a separator 405 may be attached at a terminal end of a given transporter 400. In some embodiments, a separator 405 may be removably attached at a terminal end of a given transporter 400.

In some embodiments, a separator 405 may be a cap 701, radiation protective media plate 703, end support plate 705, cover 709, screw type end cap 711, flange type cover 809, screw type cover 815, wedge type end cap 819, portion thereof, combination thereof, and/or the like.

In some embodiments, separators 405 may be metal alloys and/or in some cases may be at least partly non-metallic products such as dense rubber materials or high-density plastics. In some embodiments, separators 405 may be discarded after the waste-capsule 300 has reached a waste storage site or when the waste-capsules 300 are loaded into the wellbores for final repository insertion.

Note, most of the above FIG. 4A discussion also applies to FIG. 4B. FIG. 4B illustrates a lengthwise cross-sectional diagram of a given transporter 400 containing at least three waste-capsules 300 (prepackaged capsules 300). In some embodiments, at least three of these waste-capsules 300 may be arranged end to end, longitudinally, within the given transporter 400. In some embodiments, these at least three waste-capsules 300 may be of the same or of different sizes/dimensions. In some embodiments, three or more waste-capsules 300 may be packed within a given transporter 400 to maximize loading efficiency/capacity.

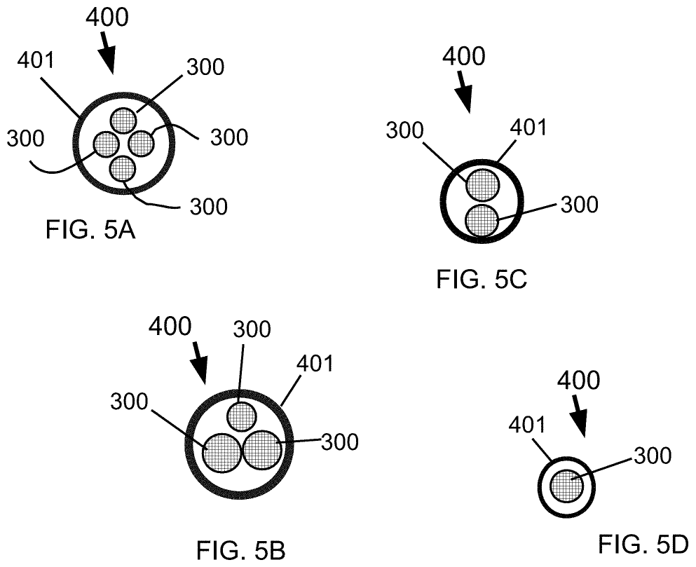

FIGS. 5A, 5B, 5C, and 5D may illustrate embodiments in which the given transporter 400 apparatus and/or waste-capsule(s) 300 may have various diameters and/or sizes; and/or the given transporter 400 may be loaded with waste-capsule(s) 300 in different configurations/arrangements. In some embodiments, a given transporter 400 may contain various quantities of waste-capsules 300 of differing sizes therein. In some embodiments, the waste-capsules 300 may have different lengths and radii. In some embodiments, the transporters 400 may have different lengths and radii, predetermined according to the different lengths and/or radii of the waste-capsules 300 to be loaded therein. In some embodiments, different sized waste-capsules 300 may be collectively utilized to maximize loading capacity/efficiency of a given transporter 400 by varying the packing operations with respect to waste-capsule 300 sizes and geometries.

In FIG. 5A, with respect to transverse width cross-sections of a given transporter 400, anywhere along the length of that given transporter 400, that cross-section may include four (4) waste-capsules 300. In FIG. 5B, with respect to transverse width cross-sections of a given transporter 400, anywhere along the length of that given transporter 400, that cross-section may include three (3) waste-capsules 300. In FIG. 5C, with respect to transverse width cross-sections of a given transporter 400, anywhere along the length of that given transporter 400, that cross-section may include two (2) waste-capsules 300. In FIG. 5D, with respect to transverse width cross-sections of a given transporter 400, anywhere along the length of that given transporter 400, that cross-section may include one (1) waste-capsule 300. In FIGS. 5A, 5B, 5C, and/or 5D, the loaded waste-capsules 300 may be of the same or different sizes and geometries and may be packed to optimize transporter 400 capacity.

It should be pointed out here, that while the embodiments illustrated in this group of figures FIGS. 5A, 5B, 5C, and 5D may show a finite number of waste-capsules 300 (e.g., from one to four) in the given cross-section, but the given transporter 400 itself may contain multiples of these waste-capsules 300 along the length of that given transporter 400. For example, a long transporter 400, may have a nominal thirty (30) foot length available for waste-capsules 300 and if the waste-capsules 300 are only ten (10) feet long (e.g., Canadian SNF assembly 100a), as many as three linear rows of waste-capsules 300 may be nominally loaded into that thirty (30) foot long transporter 400. In this situation, that transporter 400 may carry up to twelve (12) or nine (9) waste-capsules 300, depending upon the diameter of that thirty (30) foot long transporter 400 and not just the four (4) or the three (3) as shown in FIG. 5A or FIG. 5B cross-sections.

With respect to FIGS. 6A, 6B, 6C, and 6D, reference numeral “690” refers to a longitudinal (axial) centerline of the given transporter 400; reference numeral “695” refers to environment outside of the given transporter 400; and reference numeral “699” refers to the inside of the given transporter 400. In general, it is desirable to protect outside environment 695 from radiation. FIGS. 6A, 6B, 6C, and 6D illustrate partial exploded views of a given transporter 400 from a center most waste-capsule 300 (prepackaged capsule 300) to an exterior outside environment 695 of the given transporter 400. The exploded elements shown in FIGS. 6A, 6B, 6C, and 6D are exploded with respect to a radial direction from centerline 690 towards outside environment 695 of the given transporter 400. FIGS. 6A, 6B, 6C, and 6D illustrate a plurality of different wall/layer construction schemes, each of which, provides structural strength and radiation protection and containment of the nuclear waste material enclosed while being transported.

FIG. 6A illustrates a partial exploded view of a given transporter 400 from a center most waste-capsule 300 (prepackaged capsule 300) to an exterior outside environment 695 of the given transporter 400. The exploded elements shown in FIG. 6A are exploded in a radial direction from centerline 690 towards outside environment 695 of the given transporter 400.

Continuing discussing FIG. 6A, in some embodiments, from centerline 690 to outside environment 695, elements, components, parts, portions, sections, regions, portions thereof, combinations thereof, and/or the like of a given transporter 400, may be as follows: liner 601, radiation shield 603, containment layer 609, adhesive 613, and lastly, structural-jacket 611 (wall/shell 611). In some embodiments, these layers may be collectively referred to as transporter layers 401. In some embodiments, from outside environment 695 to centerline 690, the elements, components, parts, portions, sections, regions, portions thereof, combinations thereof, and/or the like of a given transporter 400, may be as follows: structural-jacket 611 (wall/shell 611), adhesive 613, containment layer 609, radiation shield 603, and lastly, liner 601. In some embodiments, the internally located waste-capsule(s) 300, may be centralized and arranged around centerline 690. In some embodiments, closest to the internally located waste-capsule(s) 300, may be cavity 407 and then followed by liner 601.

Continuing discussing FIG. 6A, in some embodiments, of the elements, components, parts, portions, sections, regions, portions thereof, combinations thereof, and/or the like of a given transporter 400, not including cavity 407 (because cavity 407 is not a component of transporter 400 per se, but rather formed from the construction of a given transporter 400), liner 601 may be closest to centerline 690 and/or closest to the internally located waste-capsule(s) 300. In some embodiments, waste-capsule 300 wall 301 may be closest to liner 601 (not including cavity 407). In some embodiments, liner 601 may be constructed from a simple metal alloy, such as, but not limited to, a steel tube which may be the lining of the innermost cavity 407 of a given transporter 400, such that the waste-capsule(s) 300 may be loaded into cavity 407 (much like loading a gun-barrel of a cannon-like device in some embodiments). In some embodiments, innermost liner 601 may be made mostly from steel, a steel alloy, and/or the like. In some embodiments, innermost liner 601 may be made at least partially from a stainless steel as the role of liner 601 is not for structural support under high stress/loads; rather, that is carried out by outermost structural jacket 611.

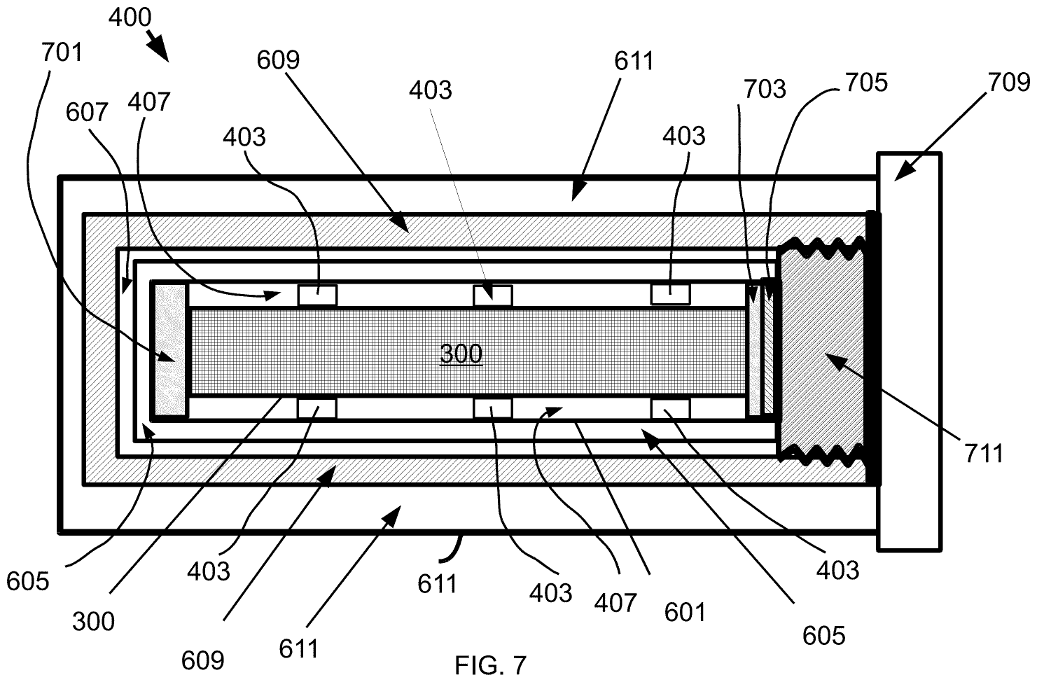

In some embodiments, liner 601 may have at least two main parts, namely, a cylindrical wall member (e.g., portions shown in FIG. 6A through FIG. 6D) and at least one end cap (e.g., end support plate 705). In some embodiments, the at least one end cap (e.g., end support plate 705) may be removably attachable to a terminal end of the cylindrical wall member (of liner 601). In some embodiments, the at least one end cap (e.g., end support plate 705) may be at least a component of the closure means. See e.g., FIG. 7 for end support plate 705.

Continuing discussing FIG. 6A, in some embodiments, liner 601 may have a wall thickness that is fixed and selected from a range of one-quarter (0.25) to one-half (0.5) inches thick, plus or minus (+/−) one-tenth (0.10) of an inch. In some embodiments, innermost liner 601 may have a wall thickness that is fixed, wherein the wall thickness may be selected from a range of one-quarter (0.25) to one-half (0.5) inches thick, plus or minus one-tenth (0.10) of an inch.

Continuing discussing FIG. 6A, in some embodiments, liner 601 may be in physical communication with radiation shield 603. In some embodiments, at least some portions of liner 601 may be physical touching at least some portions of radiation shield 603. In some embodiments, radiation shield 603 may be configured to block and/or absorb emitted radiation from SNF assemblies 100 located within waste-capsule(s) 300, that are located within liner 601. In some embodiments, this emitted radiation may be electromagnetic (e.g., gamma) and/or high energy particles (e.g., neutrons). In some embodiments, radiation shielding zone 603 may be a single composite layer or a plurality of different protective layers and/or materials, providing protection from radiation. In some embodiments, radiation shield 603 may be comprised of one or two layers, gamma radiation layer/shield 605 and/or neutron radiation layer/shield 607. In some embodiments, gamma radiation layer/shield 605 may be configured to block and/or absorb gamma rays from SNF assemblies 100. In some embodiments, neutron radiation layer/shield 607 may be configured to block and/or absorb neutron emissions from SNF assemblies 100. In some embodiments, gamma radiation layer/shield 605 may be located closer to liner 601 than neutron radiation layer/shield 607. In some embodiments, at least some portions of liner 601 may be physically touching at least some portions of gamma radiation layer/shield 605. In some embodiments, at least some portions of liner 601 may be physically attached to at least some portions of gamma radiation layer/shield 605. In some embodiments, at least some portions of gamma radiation layer/shield 605 may be physically touching at least some portions of neutron radiation layer/shield 607. In some embodiments, at least some portions of gamma radiation layer/shield 605 may be physically attached to at least some portions of neutron radiation layer/shield 607.

In some embodiments, radiation shielding layer 603 may be selected from one or more of: a gamma radiation shield 605 configured to absorb at least some gamma radiation emissions (from waste-capsule(s) 300 and/or from the removably housed radioactive material(s)); a neutron radiation shield 607 configured to absorb at least some neutron emissions (from waste-capsule(s) 300 and/or from the removably housed radioactive material(s)); a composite metal foam 617 (shield layer 617) configured to absorb at least some radiation (from waste-capsule(s) 300 and/or from the removably housed radioactive material(s)); portions thereof; combinations thereof; and/or the like.

Continuing discussing FIG. 6A, in some embodiments, gamma radiation shield 605 may be implemented inner to neutron radiation shield 607. In some embodiments, gamma radiation shield 605 may provide protection to the outside environment 695 from gamma radiation devolving from the internal waste-capsules 300. In some embodiments, gamma radiation shield 605 may be between a quarter (0.25) inch and one and one-half (1.50) inches thick, plus or minus (+/−) one-tenth (0.10) of an inch. In some embodiments, gamma radiation shielding 605 may be achieved by using materials of high density and/or of relatively high atomic numbers. For example, and without limiting the scope of the present invention, materials like lead and/or tungsten may be used for gamma radiation shielding 605. In some instances, metal foams made from steel or aluminum may be used to provide adequate radiation shielding 603/605. In some instances, depleted uranium may be used for gamma ray shielding 605.

Continuing discussing FIG. 6A, in some embodiments, neutron radiation shield 607 may be implemented inner to containment layer 609. In some embodiments, neutron radiation shield 607 may provide protection to the outside environment 695 from neutron radiation devolving from the internal waste-capsules 300. In some embodiments, neutron radiation shield 607 may be between a quarter (0.25) inch and one and one-half (1.50) inches thick, plus or minus (+/−) one-tenth (0.10) of an inch. In some embodiments, effective neutron shielding elements 607 may be made from a variety of polymer-based materials composed of an effective neutron moderator, such as, but not limited to, hydrogen and carbon, and/or the like; and/or a neutron poison, such as, but not limited to, boron, and/or the like.

Continuing discussing FIG. 6A, in some embodiments, containment layer 609 may be configured to stretch and/or deform, without tearing and/or breaching, in the event of an impact to overall transporter 400 (and its contents) up to a predetermined impact force. In some embodiments, containment layer 609 may be at least partially: flexible, conformable, compliant, stretchable, deformable, portions thereof, combinations thereof, and/or like—within predetermined limits. In some embodiments, containment layer 609 may be configured to be unbreached after the outermost structural jacket 611 has been crushed in at least one location up to a predetermined limit.

Continuing discussing FIG. 6A, in some embodiments, radiation shield 603 (or neutron radiation shield 607) may be in physical communication with containment layer 609. In some embodiments, at least some portion of radiation shield 603 (or neutron radiation shield 607) may be physically touching at least some portion of containment layer 609. In some embodiments, at least some portion of radiation shield 603 (or neutron radiation shield 607) may be physically attached to at least some portion of containment layer 609.

In some embodiments, outside of radiation shield 603, gamma radiation shield 605, neutron radiation shield 607, and/or shield layer 617, may be containment layer 609, wherein “outside of” refers to moving in a direction from cavity 407 to outside environment 695.

In some embodiments, inside of structural jacket 611 may be containment layer 609, wherein “inside of” may be with respect to a direction from outside environment 695 towards cavity 407. In some embodiments, at least some of an exterior of containment layer 609 may be in physical communication with at least some of interior surfaces of the outermost structural-jacket 611. In some embodiments, at least some of an exterior of the containment layer 609 may be attached to at least some of interior surfaces of the outermost structural-jacket 611.

In some embodiments, containment layer 609 may entirely and completely surround waste-capsule(s) 300 located therein. In some embodiments, containment layer 609, along at least most of its length, may be between one and one half (1.5) inches to three (3) inches thick, plus or minus (+/−) one half (0.5) inch. In some embodiments, containment layer 609 may have a fixed resting wall thickness, wherein the resting wall thickness may be selected from a range of one and one half (1.5) inches to three (3) inches thick, plus or minus one-half (0.5) inch.

In some embodiments, when the at least one terminal end of a given transporter 400 may be removably closed, then containment layer 609 may completely surround the innermost liner 601 and the inner cavity 407 (that is within liner 601).

In some embodiments, containment layer 609 may be mostly constructed of one or more of: polyethylene (PE), low-density polyethylene (LDPE), linear low-density polyethylene (LLPE), high-density polyethylene (HDPE), nylon, polyethylene terephthalate (PET), polyethylene terephthalate polyester (PETP), polytrimethylene terephthalate (PTT), polybutylene terephthalate (PBT), polypropylene (PP), polyvinyl chloride (PVC), polyamide, polystyrene, ethylene vinyl acetate (EVA), ethylene methyl acrylate (EMA), ethylene vinyl alcohol (EVOH), polytetrafluoroethylene (PTFE), perfluoroalkoxy alkane, fluorinated ethylene propylene (FEP), polycarbonate, acrylic, plastic with elastic additive(s), elastomer, silicone, synthetic rubber, natural rubber, portions thereof, combinations thereof, and/or the like.

In some embodiments, containment layer 609 may comprise at least two main parts, namely, a cylindrical wall member and at least one end cap (e.g., end cap 711 or end cap 819). In some embodiments, the at least one end cap (e.g., end cap 711 or end cap 819) may be removably attachable to a terminal end of the cylindrical wall member. In some embodiments, the at least one end cap (e.g., end cap 711 or end cap 819) may be at least a component of the closure means. In some embodiments, containment layer 609 may also comprise screw type end cap 711 and/or wedge type end cap 819.

In some embodiments, containment layer 609 may be at least one layer. In some embodiments, containment layer 609 may be a plurality of layers (e.g., a plurality of sublayers). In some embodiments, containment layer 609 may be a laminate comprising a plurality of layers (e.g., a plurality of sublayers).

Continuing discussing FIG. 6A, in some embodiments, surfaces of containment layer 609 disposed away from centerline 690 may be adhered to internal surfaces of structural-jacket 611 using one or more adhesive(s) 613. In some embodiments, surfaces of containment layer 609 disposed away from centerline 690 may be adhered to internal surfaces of structural-jacket 611 using one or more layers of adhesive(s) 613.

Note, some embodiments of transporter 400 may omit adhesive 613.

Continuing discussing FIG. 6A, in some embodiments, a most exterior layer of a given transporter 400 may be structural jacket 611. In some embodiments, the outermost structural-jacket 611 may provide a majority of rigidity and/or structural support for a given transporter 400 with its internally removably housed radioactive material(s) (e.g., that may be within the at least one waste-capsule 300 and wherein the at least one waste-capsule 300 may be removably housed within inner cavity 407). In some embodiments, structural-jacket 611 may provide structural support and/or structural rigidity to the given transporter 400 and its contents and its interior layers. In some embodiments, structural-jacket 611 (exterior wall 611) may be a cylindrical shell. In some embodiments, structural-jacket 611 may be structural and a protective element circumscribing the transporter 400 externally. In some embodiments, an exterior of structural jacket 611 may be in communication with at least a portion of outside/external environment 695. In some embodiments, an exterior of structural-jacket 611 may be painted, coated, marked with indicia, portions thereof, combinations thereof, and/or the like. In some embodiments, an interior of structural-jacket 611 may be in physical communication with at least a portion of adhesive(s) 613 and/or at least a portion of containment layer 609. In some embodiments, an interior of structural-jacket 611 may be physically attached to at least a portion of adhesive(s) 613 and/or to at least a portion of containment layer 609.

Continuing discussing FIG. 6A, in some embodiments, structural-jacket 611 may be constructed from a high-strength steel, steel alloy, titanium, alloys thereof, and/or the like that provides protection, puncture resistance, strength and durability to transporter 400. In some embodiments, structural jacket 611 may not be constructed from stainless-steel. In some embodiments, a steel material and/or the like for structural jacket 611 may have a yield strength of 150,000 psi (pounds per square inch) or greater. This type of steel is routinely available in major industries, particularly in oil and gas operations drilling operations. In some embodiments, the steel material and/or the like may have a yield strength much greater than the relatively “soft” stainless-steel currently utilized in the prior art transport containers 200/221.

In some embodiments, the outermost structural jacket 611, before an impact, may have a yield strength of at least 150,000 pounds per square (psi) inch while having a wall thickness of two and one-quarter (2.25) inches or less. Note, this requirement eliminates stainless steel as a material of construction for structural jacket 611 because stainless steel of two and one-quarter (2.25) inches or less in wall thickness has a yield strength of much less than the minimum required 150,000 pounds per square (psi).

In contrast, the yield strength of the stainless steel used in prior art examples is as low as 50,000 psi. This low level of yield requires much thicker walled structures to protect the contents of the prior art transporters shown in FIG. 2A and FIG. 2B. The accrued benefit touted by the prior art is that the stainless steel is “corrosion resistant,” however, it should be noted that there is no need for long-term corrosion resistance in at least some embodiments of transporter 400, since the radioactive waste containing waste-capsule(s) 300 may only be in transit on the order of days in controlled road and/or rail conditions; and it is the radioactive waste containing waste-capsule(s) 300 that are eventually deposited in the final deeply underground repository and not the transporters 400 themselves. Corrosive problems may be insignificant or very limited under these transient travel conditions.

Continuing discussing FIG. 6A, in some embodiments, an external diameter of the structural-jacket 611 may be between eighteen (18) and thirty-six (36) inches, plus or minus (+/−) one (1) inch. In some embodiments, a wall thickness of structural-jacket 611 may be from one-half (0.5) inch to two (2) inches, plus or minus (+/−) one-quarter (¼) of an inch steel (and/or steel like material).

Note, a further liability of the stainless-steel use is that of a thicker wall requirement of the prior art devices makes for heavier containers 200/221 without the attendant increase in strength and crash survivability. The prior art devices 200/221 are significantly heavier and bigger, but with less strength and crash survivability, as compared against a transporter 400 (with waste-capsule(s) 300 [with radioactive material(s)]).

FIG. 6B illustrates a partial exploded view of a given transporter 400 from a center most waste-capsule 300 (prepackaged capsule 300) to an exterior outside environment 695 of the given transporter 400. The exploded elements shown in FIG. 6B are exploded in a radial direction from centerline 690 towards outside environment 695 of the given transporter 400. In some embodiments, containment layer 609 may comprise a plurality of magnets 615. In some embodiments, embedded within the containment layer 609 may be a plurality of magnetic strips 615. In some embodiments, plurality of magnetic strips 615 may be configured to magnetically attach the containment layer 609 to outermost structural jacket 611. In some embodiments, the plurality of magnets 615 may be plurality of magnetic strips 615. In some embodiments, plurality of magnets 615 may be embedded within containment layer 609. In some embodiments, plurality of magnets 615 may be attached to containment layer 609. In some embodiments, plurality of magnets 615 may be on an inside (interior side), outside (exterior side), and/or interior portion of containment layer 609. In some embodiments, plurality of magnets 615 may be configured to facilitate attachment of containment layer 609 to structural-jacket 611, via magnetic attraction, as structural jacket 611 may be a ferrous material. In some embodiments, plurality of magnets 615 may have lengths that run substantially perpendicular to centerline 690.

In some embodiments, plurality of magnetic strips 615 may be disposed as a plurality of distinct annular rings along a length of containment layer 609. In some embodiments, the planes formed by diameters of the plurality of magnetic strips 615 may be at least substantially perpendicular to center axis 690. In some embodiments, plurality of distinct annular rings of magnets 615 may be non-touching with respect to each other. In some embodiments, a given annular ring magnet 615 (selected from the plurality of magnetic strips 615) may be continuous or broken into a plurality of non-touching strips.

Note, any containment layer 609 shown in the drawing figures may or may not have plurality of magnets 615.

In some embodiments, gamma radiation shield 605 may be closer to center axis 690 than neutron radiation shield 607 is to center axis 690, see e.g., FIG. 6A and FIG. 6B. Whereas, in other embodiments, the opposite configuration may be implemented, wherein neutron radiation shield 607 may be closer to center axis 690 than gamma radiation shield 605 is to center axis 690.

FIG. 6C illustrates a partial exploded view of a given transporter 400 from a center most waste-capsule 300 (prepackaged capsule 300) to an exterior outside environment 695 of the given transporter 400. The exploded elements shown in FIG. 6C are exploded in a radial direction from centerline 690 towards outside environment 695 of the given transporter 400. In some embodiments, gamma radiation shield 605 and neutron radiation shield 607 may be replaced a single novel material(s) layer 617 that combines properties of gamma protection and neutron absorption. These new materials may belong to a class of composite metal foams (CMF) and/or their derivatives which provide both radiation protection and structural strength. An additional or an alternative type of composite protective layer for shield layer 617, may belong to a set of novel shielding materials of flexible embedded ceramics, such as SILFLEX manufactured by American Ceramic Technology (CA). SILFLEX may be between twenty-five to fifty percent (25-50%) lighter than lead and twice as effective in radiation shielding. Embedded within the flexible ceramic are radiation attenuating materials such as lead, bismuth, and/or tungsten. In some embodiments, shield layer 617 may provide intrinsic structural strength and an ability to compress itself spongelike, during a major impact thus absorbing impact loads. In some embodiments, shield layer 617 may provide radiation protection both from gamma and neutron radiation. This allows protection of the outside environment 695. In some embodiments, shield layer 617 may comprise one or more of: composite metal foam (CMF), flexible embedded ceramic, SILFLEX, lead, bismuth, tungsten, portions thereof, combinations thereof, and/or the like. In some embodiments, this shield layer 617 may be implemented inner to the containment layer 609 and may completely surround internal cavity 407 and thus covers the radioactive prepackaged waste-capsule(s) 300 completely. In some embodiments, shield layer 617 may be between a quarter (0.25) inch to one and one quarter (1.25) inches thick, plus or minus (+/−) one-tenth (0.10) of an inch.

In some embodiments, a given transporter 400 may comprise one or more of: radiation shield 603, gamma radiation shield 605, neutron radiation shield 607, shield layer 617, portions thereof, combinations thereof, and/or the like. In the drawing figures, reference numerals 603, 605, 607, and 617 may be replaced and/or used interchangeably with each other for various embodiments of transporters 400.

FIG. 6D illustrates a partial exploded view of a given transporter 400 from a center most waste-capsule 300 (prepackaged capsule 300) to an exterior outside environment 695 of the given transporter 400. The exploded elements shown in FIG. 6D are exploded in a radial direction from centerline 690 towards outside environment 695 of the given transporter 400. In some embodiments, shield layer 617 may be disposed between structural jacket 611 and containment layer 609. In some embodiments, shield layer 617 may be in physical communication with structural jacket 611 and with containment layer 609. In some embodiments, shield layer 617 may be physically attached to structural jacket 611 and/or to containment layer 609. In some embodiments, liner 601 may be disposed between containment layer 609 and exteriors of waste-capsule(s) 300. In some embodiments, containment layer 609 may be disposed between shield layer 617 and liner 601. In some embodiments, containment layer 609 may be in physical communication with shield layer 617 and with liner 601. In some embodiments, containment layer 609 may be physically attached to shield layer 617 and/or to liner 601.

In some embodiments, radiation shielding layer 603, 605, 607, and/or 617 may be disposed between the outermost structural-jacket 611 and the containment layer 609, see e.g., FIG. 6D. Whereas, in some embodiments, radiation shielding layer 603, 605, 607, and/or 617 may be disposed between the innermost liner 601 and containment layer 609, see e.g., FIG. 6A through FIG. 6C.

FIG. 7 illustrates a lengthwise cross-sectional diagram of a given transporter 400 containing at least one waste-capsule 300. In some embodiments, the various layers of transporter 400 may be as shown and described according to FIG. 6A to FIG. 6D. In some embodiments, an overall shape of the various layers of transporter 400 may be substantially as a hollow cylinder that this closed at one terminal end and open, but sealable at the other opposing terminal end, as shown in FIG. 7. This closed at one end and open at the other end hollow cylinder shape forms cavity 407, which is sized and shaped to removably receive at least one waste-capsule 300, cap 701, internal supports 403, radiation protective media plate 703, end support plate 705, portions thereof, combinations thereof, and/or the like. In some embodiments, while transporter may be open at one end, cap 701 may be inserted first into cavity 407; then at least one waste-capsule 300; then internal supports 403 (as needed/desired to keep waste-capsule 300 relatively fixed within cavity 407); then radiation protective media plate 703; and then end support plate 705. In some embodiments, end support plate 705 may be constructed of steel or similar high strength alloys. In some embodiments, cap 701 may butt up against the internal closed end of transporter 400, which may be a portion of liner 601. If more than one waste-capsule 300 is being inserted into cavity 407, then at least one separator 405 may be used to separate linearly arranged waste-capsules 300 within cavity 407. Then to finish removably sealing the open end of that now loaded transporter 400, an end cap (e.g., screw type end cap 711 or wedge type end cap 819) is added next to 705; and lastly, a cover 709 is sealed over that former open end of transporter 400. In some embodiments, cover 709 may be a flange type cover 809 that may be removably bolted to structural-jacket 611 and/or cover 709 may be a screw type cover 815 that may be threaded onto complimentary threads 817 of structural-jacket 611.

Continuing discussing FIG. 7, in some embodiments, once a given loaded transporter 400 reaches its final repository location/site, this loading process may be reversed, to remove the at least one waste-capsule 300 from cavity 407, so that the at least one waste-capsule 300 may then be stored/disposed of within that final repository (which may be deeply under-ground); and the now empty transporter 400 may be reused. In some embodiments, to remove the at least one waste-capsule 300 from cavity 407, first cover 709 may be removed (unbolted and/or unscrewed); then the end cap (711 or 819) may be removed; then end support plate 705 may be removed; then radiation protective media plate 703 may be removed; and finally, the at least one waste-capsule 300 may now be removed from cavity 407. In some embodiments, cap 701, internal supports 403, radiation protective media plate 703, and/or end support plate 705 may be reused or discarded.

Continuing discussing FIG. 7, in some embodiments, cap 701 may provide lateral (axial) support to waste-capsule(s) 300 inside the given transporter 400. In some embodiments, cap 701 may be located within cavity 407. In some embodiments, cap 701 may be disc shaped, having a diameter that is less than a diameter of liner 601. In some embodiments, cap 701 may be about one-half (0.5) inch to one (1) inch thick, plus or minus (+/−) a quarter (0.25) inch. In some embodiments, end cap 701 may be made of steel or similar high strength alloy.

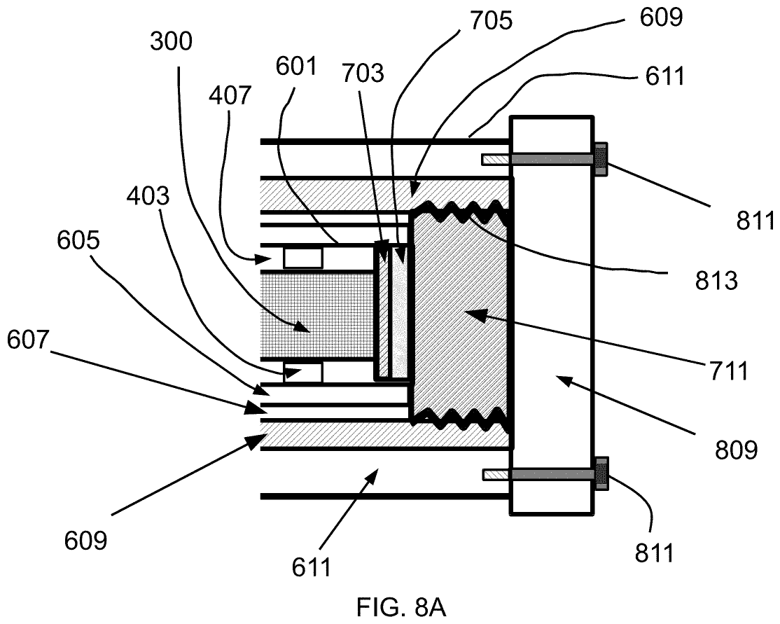

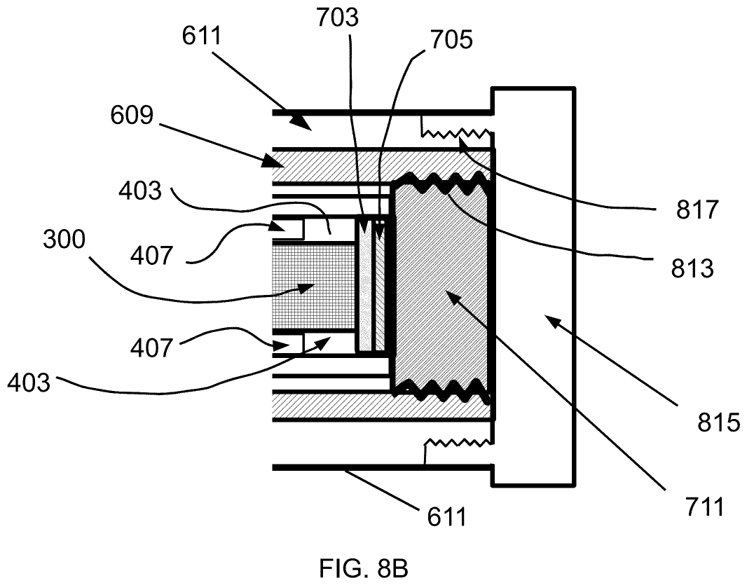

Continuing discussing FIG. 7, in some embodiments, cover 709 may be an exterior most closure element of transporter 400. In some embodiments, an exterior side of cover 709 may be in communication with at least a portion of outside environment 695. In some embodiments, an interior side of cover 709 may be in physical communication with at least a portion of the end cap (e.g., 711 or 819) and with at least portions of structural jacket 611. In some embodiments, cover 709 may be configured to removably seal over (close) a terminal end of a given transporter 400. In some embodiments, cover 709 may be removably attached to structural-jacket 611. In some embodiments, cover 709 may be flange type cover 809 (see e.g., FIG. 8A) or screw type cover 815 (see e.g., FIG. 8B). In some embodiments, cover 709 may be appended on an open terminal end of transporter 400. In some embodiments, cover 709 may provide lateral and circumferential support and additional lateral closure for containment layer 609. In some embodiments, cover 709 may be constructed of steel or metal alloy similar to the structural-jacket 611 of the transporter 400. In some embodiments, cover 709 may be removed such that prepackaged waste-capsule(s) 300 loading and/or unloading into and/or out of cavity 407 of transporter 400 may be accomplished. In some embodiments, cover 709 may physically contact elements inside the transporter 400 including, but not limited to, portions of structural-jacket 611, portions of containment layer 609, portions of the end cap (e.g., 711 or 819), portions thereof, combinations thereof, and/or the like. In some embodiments, a wall thickness of cover 709 may be 150% to 200% thicker than the thickness the wall of structural-jacket jacket 611. In some embodiments, an outer diameter of cover 709 may be at least 10% greater than the external diameter of structural-jacket 611.

Continuing discussing FIG. 7, in some embodiments, the end cap (e.g., 711 or 819) may be used to help confine the internal elements of the given transporter 400. In some embodiments, the end cap (e.g., 711 or 819) may be internally implemented inside and in immediate contact with cover 709, in an axial direction. In some embodiments, the end cap (e.g., 711 or 819) may be made of the same material as the containment layer 609. In some embodiments, the end cap (e.g., 711 or 819) may be threaded and/or fitted on to the walls of the container layer 609 and in direct contact with the attached cover 709. In some embodiments, the end cap (e.g., 711 or 819) may provide additional lateral closure for the container layer 609 such that the container layer 609 and its extensions and/or attachments may continuously and completely surround and enclose the waste-capsule(s) 300 contents of the transporter 400. In some embodiments, the end cap (e.g., 711 or 819) may have a thickness that may be at least 150% to 300% as thick as the containment layer 609 thickness. In some embodiments, a diameter of the end cap (e.g., 711 or 819) may be at least as large as a diameter of the neutron radiation shield 607 (and/or the other radiation shields described above) which may be implemented inside container layer 609. In some embodiments, the end cap (e.g., 711 or 819) may contact container layer 609 directly to ensure a complete wrap or enclosure of the waste-capsule(s) 300 carried inside the given transporter 400. This construction and arrangement allows containment layer 609 to keep all waste-capsule 300 contents safely confined, surrounded and enclosed during an adverse event. So, essentially the end cap (e.g., 711 or 819) is a part of containment layer 609. In some embodiments, the end cap (e.g., 711 or 819) may be disposed opposite from cap 701.

Continuing discussing FIG. 7, in some embodiments, interior to the end cap (e.g., 711 or 819), in an axial direction, may be implemented end support plate 705. In some embodiments, end support plate 705 may be located within cavity 407. In some embodiments, with respect to an axial direction, end support plate 705 may be disposed between the end cap (711 or 819) and radiation protective media plate 703. In some embodiments, with respect to the direction that is parallel with the center axis 690, end support plate 705 may be disposed between the radiation protective media plate 703 and the end cap (which may be end cap 711 or end cap 819). In some embodiments, end support plate 705 may provide lateral (axial) support to waste-capsule(s) 300 inside the given transporter 400. In some embodiments, end support plate 705 may be disc shaped, having a diameter that is less than a diameter of liner 601. In some embodiments, end support plate 705 may be about one-half (0.5) inch to one (1) inch thick, plus or minus (+/−) a quarter (0.25) inch. In some embodiments, end support plate 705 may be a removable component of the innermost liner 601.

Continuing discussing FIG. 7, in some embodiments, interior to this end support plate 705, in an axial direction, may be implemented radiation protective media plate 703. In some embodiments, radiation protective media plate 703 may be located within cavity 407. In some embodiments, with respect to an axial direction, radiation protective media plate 703 may be disposed between end support plate 705 and a terminal end portion of a given waste-capsule 300. In some embodiments, radiation protective media plate 703 may be configured to absorb at least some emitted radiation from the radioactive material(s) that may be removably housed within the inner cavity 407. In some embodiments, radiation protective media plate 703 may butt up against a terminal end portion of at least one waste-capsule 300 removably housed within the inner cavity 407, wherein the at least one waste-capsule 300 may house the radioactive material(s). In some embodiments, radiation protective media plate 703 may be constructed of the same protective material used in radiation shields 603, 605, 607, 617, and/or the like. In some embodiments, radiation protective media plate 703 may be disc shaped, having a diameter that is less than a diameter of liner 601. In some embodiments, radiation protective media plate 703 may be about one-half (0.5) inch to one (1) inch thick, plus or minus (+/−) a quarter 0.25 inch. In some embodiments, radiation protective media plate 703 may ensure that the waste-capsule(s) 300 may be completely physically surrounded by the protective media configured for radiation shielding, including at terminal end(s) of the waste-capsule(s) 300.

In some embodiments, an overall shape of transporter 400 may be a hollow cylinder that when not sealed and not loaded is open at both ends. In such embodiments, both open ends may be closed and/or sealed as shown for the closeable one end in FIG. 7 (and/or as shown in FIGS. 8A to 8C).

In some embodiments, cap 701 may be omitted. In some embodiments, cap 701 may be replaced with radiation protective media plate 703 and/or end support plate 705.

FIG. 8A illustrates a partial lengthwise cross-sectional diagram of a given transporter 400 containing at least one waste-capsule 300, with a focus on one (terminal) end of the given transporter 400, showing the opening, loading, and/or closure end of the given transporter 400, with a bolt 811 on flange cover 809. Note, the transporter 400 of FIG. 8A may be open and removably closeable/sealable at one terminal end and closed at its opposing terminal; or the transporter 400 may open at both terminal ends, with both or either open terminal end configured to be removably sealed/closed as shown in FIG. 8A. In some embodiments, cover 709 may be flange type cover 809 that is configured to be removably bolted onto structural-jacket 611 using bolts 811. In some embodiments, the end cap may be screw type end cap 711 that is configured to be removably threaded to threads 813 of containment layer 609. In some embodiments, screw type end cap 711 may comprise threads that are complimentary to threads 813 of containment layer 609. In some embodiments, flange type cover 809 may be appended on an open terminal end of transporter 400. In some embodiments, flange type cover 809 may be removably attached to the transporter 400 by bolts 811. In some embodiments, flange type cover 809 may provide lateral and circumferential support and additional lateral closure for containment layer 609. In some embodiments, flange type cover 809 may be constructed of steel or metal alloy similar to the structural jacket 611 of the transporter 400. In some embodiments, flange type cover 809 may be removed such that prepackaged waste-capsule(s) 300 loading and/or unloading into and/or out of cavity 407 of transporter 400 may be accomplished. FIG. 8A may show an embodiment of flange type cover 809 which is bolted to the external structural jacket 611 by a plurality of bolts 811. In some embodiments, flange type cover 809 may be securely bolted to the end wall of structural jacket 611 of transporter 400, using bolts 811, after the waste-capsule(s) 300 are loaded into transporter 400. In some embodiments, to remove the waste-capsule(s) 300 from transporter 400, bolts 811 may be removed from flange type cover 809. In some embodiments, bolts 811 may be radially disposed around the periphery of flange type cover 809 and screwed into the wall of structural-jacket 611. In some embodiments, an end wall of structural jacket 611 may have a plurality of threaded bolt receiving holes configured to receiving the plurality of bolts 811. In some embodiments, flange type cover 809 may physically contact elements inside the transporter 400 including, but not limited to, portions of structural-jacket 611, portions of containment layer 609, portions of the end cap (e.g., 711 or 819), portions thereof, combinations thereof, and/or the like. In some embodiments, a wall thickness of flange type cover 809 may be 150% to 200% thicker than the thickness the wall of structural-jacket 611. In some embodiments, a diameter of flange type cover 809 may be at least 10% greater than the external diameter of structural-jacket 611.

FIG. 8B illustrates a partial lengthwise cross-sectional diagram of a given transporter 400 containing at least one waste-capsule 300, with a focus on one end of the given transporter 400, showing the opening, loading, and/or closure end of the given transporter 400, with a screw on threaded flange cover 815 (screw type cover 815) as cover 709. Note, the transporter 400 of FIG. 8B may be open and removably closeable/sealable at one terminal end and closed at its opposing terminal; or the transporter 400 may open at both terminal ends, with both or either open terminal end configured to be removably sealed/closed as shown in FIG. 8B.

FIG. 8B may illustrate an embodiment of a screw type (flange) fitting 815 on the transporter 400. In some embodiments, screw type cover 815 may be a type of cover 709. In some embodiments, these screw fitting(s) 815 may be appended to an open terminal end of the given transporter 400. In some embodiments, screw type cover 815 may be removably attached to a portion of structural-jacket 611. In some embodiments, screw type cover 815 may be connected to structural jacket 611 by threaded connection 817. In some embodiments, threaded connection 817 may be disposed around an inside periphery of a terminal end wall portion of the structural jacket 611. In some embodiments, screw type cover 815 may be removably attached to structural-jacket 611 (of transporter 400) by threaded connection 817. In some embodiments, screw type cover 815 may be securely connected to threaded connection 817 of structural jacket 611 of transporter 400 after the waste-capsule(s) 300 are loaded into the transporter 400. In some embodiments, threaded connection 817 may be internal/inside threads at a terminal end of structural jacket 611. In some embodiments, threads of screw type cover 815 may be complimentary to threads of threaded connection 817. In some embodiments, screw type cover 815 may provide lateral and circumferential support and/or additional lateral closure for the containment layer 609. In some embodiments, screw type cover 815 may be constructed of steel or metal alloy similar to structural jacket 611 of transporter 400. In some embodiments, screw type cover 815 may be removed such that loading and/or unloading of the prepackaged waste-capsule(s) 300 into and/or out of cavity 407 may be accomplished. In some embodiments, screw type cover 815 may physically contact elements inside the transporter 400 including, but not limited to, portions of structural-jacket 611, portions of containment layer 609, portions of the end cap (e.g., 711 or 819), portions thereof, combinations thereof, and/or the like. In some embodiments, a wall thickness of screw type cover 815 may be 150% to 200% thicker than the thickness of the wall of structural-jacket 611. In some embodiments, a largest external diameter of screw type cover 815 may be at least 10% greater than the external diameter of structural-jacket 611.

Note, while FIG. 8B may show a screw type end cap 711 but screw type cover 815 embodiment may also be used in an embodiment utilizing a wedge type 819 configuration of the end cap.

In some embodiments, cover 709 (which may be cover 809 or cover 815) may be a removable component of the outermost structural jacket 611; and cover 709 (which may be cover 809 or cover 815) may be removably attachable to a cylindrical wall portion of the outermost structural jacket 611.

In some embodiments an adhesive or sealant, usually referred to in industry as “dope,” may be used on threads of: screw type end cap 711, threads 813, bolt 811 threads, bolt 811 receiving hole threads, threads of screw type cover 815, threaded connection 817, portions thereof, combinations thereof, and/or the like, to maximize the seal and produce a better adhesion contact with the respective mating surfaces.

FIG. 8C illustrates a partial lengthwise cross-sectional diagram of a given transporter 400 containing at least one waste-capsule 300, with a focus on one end of the given transporter 400, showing the opening, loading, and/or closure end of the given transporter 400, with a wedge type end cap 819. Note, the transporter 400 of FIG. 8C may be open and removably closeable/sealable at one terminal end and closed at its opposing terminal; or the transporter 400 may open at both terminal ends, with both or either open terminal end configured to be removably sealed/closed as shown in FIG. 8C. In some embodiments, wedge type end cap 819 may provide additional lateral closure for container layer 609, such that container layer 609 and/or its attachments may continuously and completely surround and enclose waste-capsule(s) 300 contained within cavity 407 transporter 400. In some embodiments, wedge type end cap 819 may be used to help enclose at least some of the internal elements of transporter 400. In some embodiments, wedge type end cap 819 may be made of the same material(s) as containment layer 609. In some embodiments, wedge type end cap 819 may be formed/shaped in a frusto-conical and/or wedge shaped three-dimensional (3D) fashion such that wedge type end cap 819 may be force/friction fitted against at least some portions of the internal/inside walls of container layer 609. In some embodiments, wedge type end cap 819 may be internally implemented inside and in immediate contact with the transporter flange 809, with respect to an axial direction. In some embodiments, a thickness of wedge type end cap 819 may be at least 150% to 300% as thick as the containment layer 609 lateral wall thickness. In some embodiments, the larger diameter of wedge type end cap 819 may be just smaller than the internal diameter of structural jacket 611. In some embodiments, the smaller diameter of the wedge type end cap 819 may be about as wide as the diameter of the neutron protection layer 607. In some embodiments, at least some portions of wedge type end cap 819 exterior surfaces (e.g., the conical surfaces) may directly physically contact at least some internal/inside surfaces of container layer 609, to ensure a complete wrap or enclosure of the waste-capsule(s) 300 carried inside cavity 407 of transporter 400.

In some embodiments, an adhesive or sealant, usually referred to in industry as “dope,” may be used within the sides (faces) of wedge type end cap 819 to maximize the seal and produce a better contact with containment layer 609.

In some embodiments, wedge type end cap 819 construction and/or arrangement may allow the containment layer 609 to keep all waste-capsule(s) 300 contents safely confined within the overall containment layer 609 (including its attached end cap) during an adverse event.

In some embodiments, the end cap (which may be end cap 711 or end cap 819) may be a removable component of containment layer 609 and the end cap (which may be end cap 711 or end cap 819) may be removably attachable to a cylindrical wall portion of the containment layer 609. In some embodiments, with respect to the direction that is parallel with the center axis 690, the end cap (which may be end cap 711 or end cap 819) may be disposed between end support plate 705 and cover 709 (which may be cover 809 or cover 815).

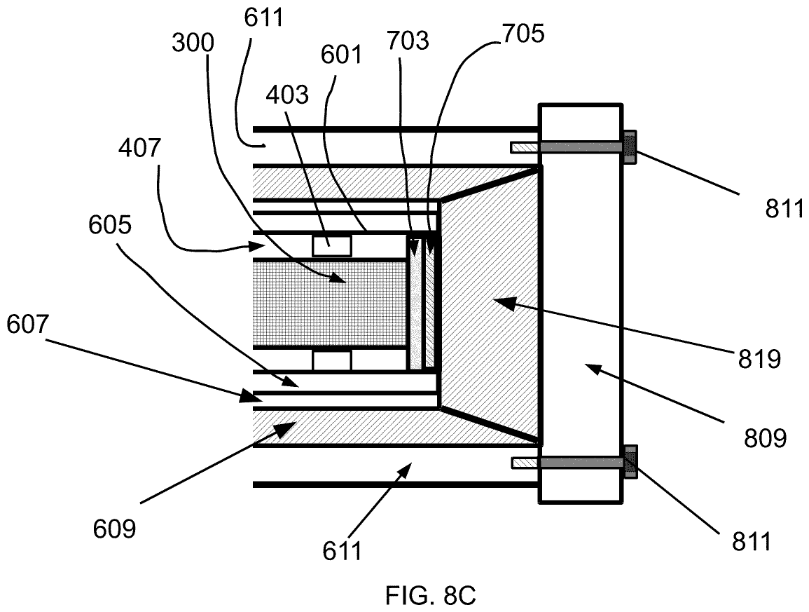

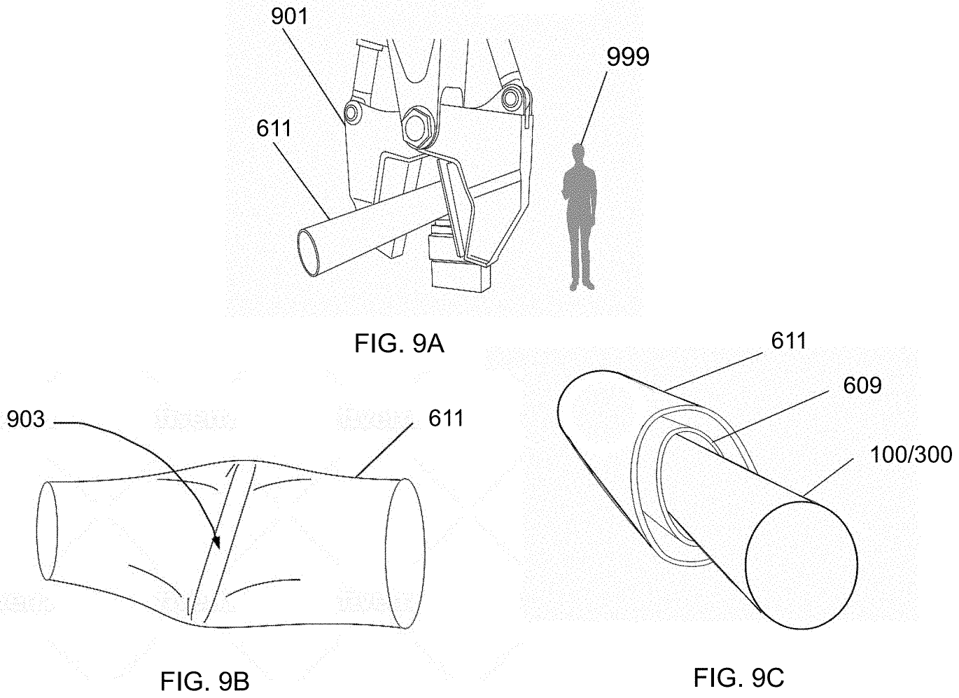

FIG. 9A, 9B, and 9C together may illustrate a process wherein an apparatus similar to transporter 400 undergoes a destructive testing procedure. The intent of this type of test is to simulate a crash event and to quantify and illustrate how external forces physically may affect a set of concentric pipes with filled annuli, similar to what the transporter 400 may mechanically represent when loaded with HLW/SNF waste-capsules 300 in transit. The test also may indicate how the transporter 400 may behave under maximum loading conditions similar to what may be expected in a major operations accident or in a transportation mishap with a transporter 400 type device in the field.

The type of crush test indicated herein (see e.g., FIG. 9A, 9B, and 9C), is possible on a simulated type transporter 400. It should be noted that with the prior art transporters 200/221, it is impossible to do a complete full-size test on these massive prior art transportation systems. In the prior art, transport systems have been subjected to “drop tests” from a few feet, usually less than twenty (20) feet high, to simulate an accident. The prior art transporters 200/221 have been subjected to rather spectacular-looking but operationally unrealistic crashes by fast-moving train engines on a railway track.

Some published results of prior art transporters 200/221 are based on simplified or limited finite element analysis (FEA) and on inaccurate extrapolation of small physical model data. It has been generally accepted that these miniature physical model data are incapable of correctly representing some phenomenon, such as inertia effects and the induced temperature effects, or rapid thermal changes occurring during an operational event, such as a severe crash or massive departure from the normal operations.

However, in the current application, full sized embodiments of transporter 400 (or a simulated transporter 400 without radioactive materials) may be readily tested with available commercial experimental instrumentation equipment and devices.

FIG. 9A which shows a large commercial LaBounty type shear machine 901 of the type normally used to demolish highway infrastructure systems, demolish reinforced concrete buildings, in scrap metal processing and to crimp large thick-walled steel pipelines in the field. A typical shear machine 901 in commercial use today, may produce a force from 100 tons to in excess of 600 tons force on a given surface. FIG. 9A may also show a generic test pipe 611 (equivalent to structural jacket 611), simulating a comparable internally loaded transporter device 400. Operationally, the pipe 611 is fixed in the jaws of the shear machine 901. The full test load is applied hydraulically to the pipe 611 during the test and the jaws of the shear machine 901 transfer this massive load to walls of the pipe 611. A standing FIG. 999 of a human is shown solely for size comparison purposes.

FIG. 9B illustrates a section of pipe 611 after the shear load has been applied to the pipe 611. The impact (compression) location 903 of FIG. 9B indicates the area where the load was applied to the pipe 611 using shear machine 901. The result of the applied load is shown on the buckled pipe 611 with crushed section 903.

FIG. 9C illustrates a section of the concentric pipes 611 and 609 (equivalent to structural-jacket 611 and containment layer 609) with a cut away portion to illustrate the internal disposition of the pipe 611 and its contents. Specifically, pipe 611 may represent structural-jacket 611, pipe 609 may represent and behave as containment layer 609 of the transporter 400. It should be realized that even after a massive load imposed by LaBounty shear machine 901 on the outside of pipe 611, the internal cylinders of pipe 100 and pipe 300 may be still intact, even though they have been severely crushed. In FIG. 9C, pipe 100 may be equivalent to SNF assembly 100, but without radioactive materials; and pipe 300 may be equivalent to waste-capsule(s) 300, but without radioactive materials. The containment layer 609 may thus keep its internal contents (e.g., pipes 100 and/or 300) inside and within a “cocoon” of the pipe 609. The containment layer 609 may thus keep its internal contents (e.g., pipes 100 and/or 300) protected and non-breached, even after a severe crushing event. It is contemplated that in the embodiments taught by this invention, the flexible, malleable, and stretchable containment layer 609 may provide a means of keeping the inner elements of the transporter 400 secure inside the containment layer 609 even though they may be crushed or mechanically deformed. This containment feature in a crash event, allows the damaged transporter 400 to contain the HLW/SNF materials in waste-capsules 300 without any spillage even though the waste-capsules 300 may be crushed. The deformable nature of the containment layer 609 may allow for bending, stretching, and/or torsional effects without rupturing. Cleanup after a crash event may be simple since all the HLW/SNF materials are still wholly contained inside the containment layer 609 structure and not dispersed or expelled into the outside environment. These inner elements which may be protected by structural-jacket 611 and/or containment layer 609 may be: SNF assemblies 100, waste-capsule(s) 300, liner 601, gamma protection layer 605, neutron absorption layer 607, and additionally several internal supports 403, and/or caps 701, plates/plugs 703/705.

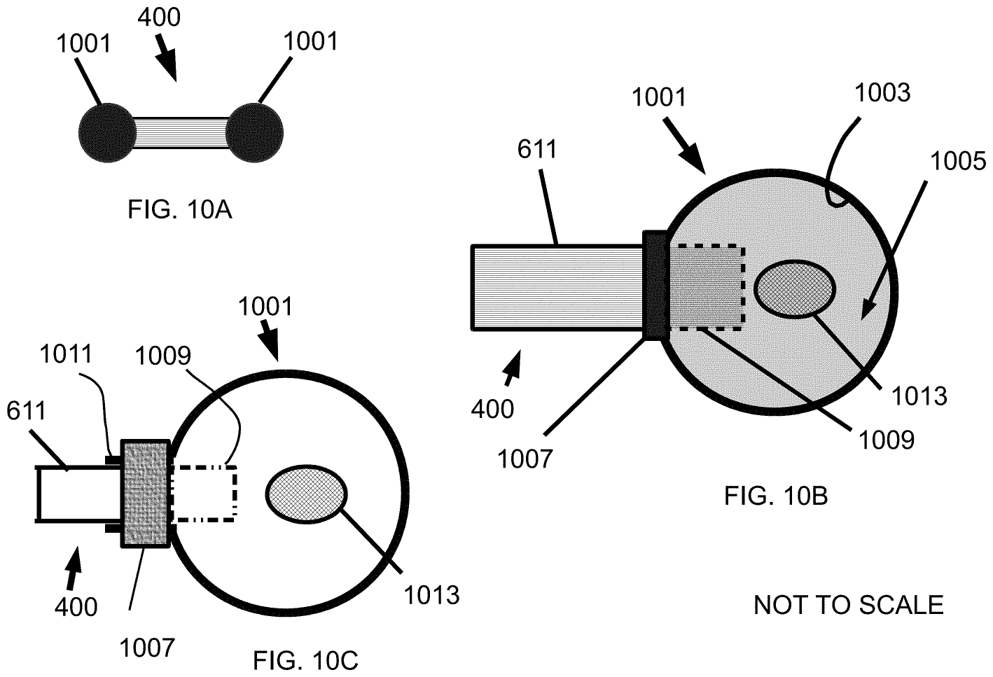

FIG. 10A illustrates at least one impact limiter 1001 attached to an end of a given transporter 400. FIG. 10A illustrates two different impact limiters 1001 attached to opposing terminal ends of a given transporter 400. In some embodiments, transporter 400 may comprise at least one impact limiter 1001. In some embodiments, the at least one impact limiter 1001 may be removably attached to an exterior of the at least one terminal end of a given transporter 400. In some embodiments, the at least one impact limiter 1001 may be configured to absorb some impacts and/or to protect the given transporter 400 from impacts of a predetermined limit. In some embodiments, impact limiter 1001 may be configured to function and/or operate as an impact shock absorber. In some embodiments, impact limiter 1001 may be configured to minimize and/or mitigate adverse consequences from impacts to transporter 400. In some embodiments, impact limiter 1001 may be configured to protect transporter 400 from impacts. In some embodiments, attachment of a given impact limiter 1001 to a given terminal end of transporter 400 may be removable attachment.

FIG. 10B illustrates how a given impact limiter 1001 may be removably connected removably to a given terminal end of structural-jacket 611 of transporter 400. In some embodiments, an exterior of impact limiter 1001 may be mostly curved and/or rounded with a predetermined radii and/or curvature. In some embodiments, the at least one impact limiter 1001 may have a substantially spherical outer shell 1003. In some embodiments, substantially spherical outer shell 1003 may have an outer diameter that is larger than an external diameter of the outermost structural-jacket 611. In some embodiments, an exterior diameter of impact limiter 1001 may be from one and one-half (1.5) to three (3) times the external diameter of structural-jacket 611, plus or minus (+/−) one (1) inch. In some embodiments, impact limiter 1001 may be substantially spherical in exterior shape with an opening configured to receive a portion of a terminal end of structural jacket 611 of transporter 400. In some embodiments, impact limiter 1001 may comprise an outer shell 1003 (outer wall 1003). In some embodiments, shell 1003 may be constructed from one or more of: flexible, puncture-proof, laminated, deformable, fabric material; aramid fibers; steel-belted rubber fabric; high density polyethylene; metal; metal alloys; portions thereof; combinations thereof; and/or the like.

Continuing discussing FIG. 10B, in some embodiments, a portion of impact limiter 1001 may extend over and surround/enclose a terminal end of transporter 400 such that a portion of structural jacket 611 is embedded a measurable distance 1009 into a body of impact limiter 1001. In some embodiments, portion 1009 of structural-jacket 611 may be about one-third (⅓) to one-half (½) of the radial diameter of impact limiter 1001 and extending into the body of impact limiter 1001. Note, reference numeral “1009” may refer to the portion of structural-jacket 611 that extends into the body of impact limiter 1001; and/or reference numeral “1009” may refer to a distance/depth of the opening into the body of impact limiter 1001 that is configured for receiving the portion of a terminal end of structural jacket 611. In some embodiments, a distance/depth of portion 1009 may be predetermined. In some embodiments, a banded clamp device 1007 may be an attachment clamp device configured to tightly, but removably, attach an external lip 1011 of impact limiter 1001 to an external portion of structural-jacket 611. See FIG. 10C for external lip 1011 of impact limiter 1001. In some embodiments, band 1007 may be an elastic member.

Continuing discussing FIG. 10B, in some embodiments, impact limiter 1001 may comprise at least one fill 1005 (filler 1005 and/or contents 1005). In some embodiments, fill 1005 may be disposed within shell 1003. In some embodiments, fill 1005 may be configured to function and/or operate to absorb and/or dampen impacts to shell 1003. In some embodiments, fill 1005 of impact limiter 1001 may provide an energy absorbing medium to impact limiter 1001 and to transporter 400 in an impact event. In some embodiments, fill 1005 may be selected from one or more of: wood, balsa wood, rubber pellets, rigid crushable metal balls, metal parts, honeycomb metal lattices, high density plastic lattices, high density plastic parts, low density foam cements, portions thereof, combinations thereof, and/or the like.

Continuing discussing FIG. 10B, in some embodiments, impact limiter 1001 may comprise at least one internally located pneumatic bladder 1013. In some embodiments, pneumatic bladder 1013 may be located within shell pneumatic bladder 1013. In some embodiments, pneumatic bladder 1013 may be implemented inside the matrix of the absorbent fill 1005 of impact limiter 1001. In some embodiments, fill 1005 may completely surround and/or supports pneumatic bladder 1013. In some embodiments, pneumatic bladder 1013 may be compressible. In some embodiments, pneumatic bladder 1013 may be a balloon-like oblate spherical device with flexible walls, between one-quarter (¼) inch and three-quarters (¾) inch thick, plus or minus (+/−) one-tenth (0.1) of an inch. In some embodiments, pneumatic bladder 1013 may be (initially) filled with a gas. In some embodiments, pneumatic bladder 1013 may be constructed from a strong rubberized material and/or elastomer. In some embodiments, pneumatic bladder 1013 may be pre-inflated to at least 105 psi (pounds per square inch) during use. In some embodiments, pneumatic bladder 1013 may be easily inserted during construction of a given impact limiter 1001 while impact limiter 1001 is being filled with absorbent fill 1005. In some embodiments, a diameter of pneumatic bladder 1013 may measure between twenty-five percent (25%) to forty percent (40%) of the external diameter of impact limiter 1001.

Operationally, upon impact on impact limiter 1001, the impulse force generated from the impact event is transmitted through walls 1003 of impact limiter 1001, through the absorbent matrix fill 1005, which partially absorbs some of the impulse, and the remaining impact force is then transferred onto the surface of the pneumatic bladder 1013 which may distort and absorb at least some of this force by allowing the bladder 1013 to distort (including compressing, stretching, and/or expanding); thus, limiting the destructive effect of the shock on the impact limiter 1001 and to transporter 400. Thus, pneumatic bladder 1013 may behave like an internal airbag and helps absorb any external impact forces.

FIG. 10C may illustrate the implementation of a circular cylindrical extended lip 1011 of impact limiter 1001 which may fit over the external terminal end of structural-jacket 611. In some embodiments, this extended lip 1011 may be an integral part of the body of impact limiter 1001. In some embodiments, this extended lip 1011 may be an integral part of shell 1003 of impact limiter 1001. In some embodiments, extended lip 1001 zone may circumferentially fit over the external terminal end of structural-jacket 611. In some embodiments, a length of extended lip 1011 may be longer than the attachment band (ring) 1007 is wide, by at least two (2) to three (3) inches, plus or minus (+/−) one-half (½) inch. In some embodiments, band 1007 may go over portions of extended lip 1001 and squeeze those portions of extended lip 1001 to the external terminal end of structural-jacket 611. In some embodiments, band 1007 may keep impact limiter 1001 attached to the external terminal end of structural jacket 611 during an impact event.

Consider a transporter 400 with a nominal twenty-six (26) inch outer diameter of the structural-jacket 611. This transporter 400 with a set of fully loaded prepackaged waste-capsules 300 (with SNF) and the other required component elements illustrated and discussed above, including two opposing impact limiters 1001, may still weigh less than 20,000 to 30,000 lbs. (pounds) gross weight. This type of transporter 400 is compared to a conventional prior art transport system which weighs about 250,000 lbs. which is at least 8 times heavier than the inventive system described herein. There are no massive equipment needs for handling the new type transporter 400 of this invention that weighs considerably less than the prior art systems. Highway (and rail) travel is simplified and special load permitting, except for radioactive transport regulations, may not be required.

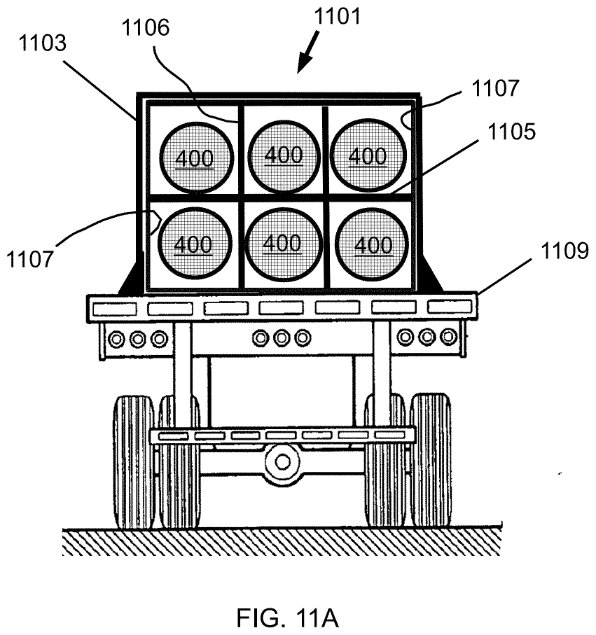

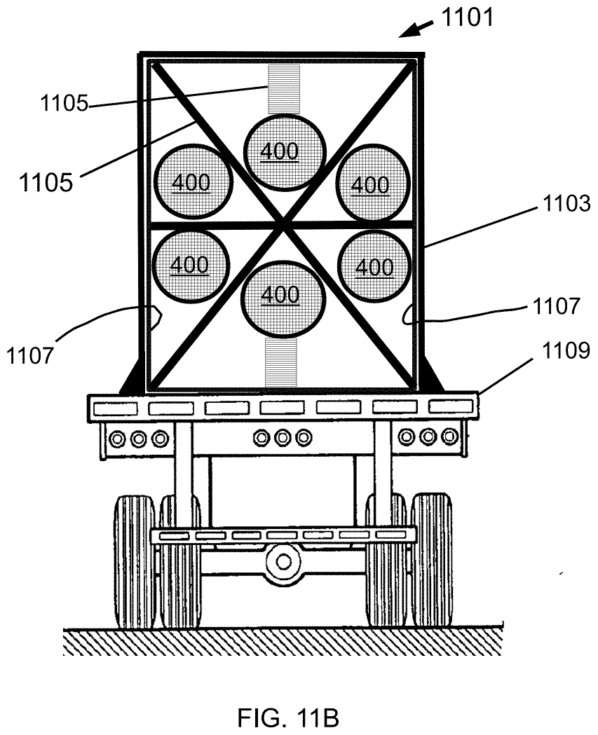

FIG. 11A may illustrate a multi-pack example of loading and packing of a plurality of transporters 400 on a mobile platform 1109 (trailer transport system 1109). In some embodiments, a plurality of transporters 400 may be loaded and arranged inside a specialized and modified shipping container type trailer system 1101. In some embodiments, shipping container type trailer system 1101 may comprise a shipping container 1103. In some embodiments, shipping container 1103 may be reinforced by a plurality of structural supports 1105. In some embodiment, at least some of structural supports 1105 may surround (internally and/or externally) the body of shipping container 1103. In some embodiments, at least some of structural supports 1105 may form a polygonal lattice-like (shelving/rack) system into which the plurality of transporters 400 are disposed (loaded/received). In some embodiments, internally (and/or exteriorly) disposed in shipping container 1103 may be a protective layer 1107. In some embodiments, protective layer 1107 may be disposed to surround the internal cavity of shipping container 1103. In some embodiments, protective layer 1107 may be radiation shield layer(s). In some embodiments, protective layer 1107 may be constructed from one or more of: lead sheets, metal foams, SILFLEX brand radiation protection or similar manufactured radiation materials, portions thereof, combinations thereof, and/or the like. In some embodiments, shipping container 1103 (with the plurality of transporters 400) may be loaded onto of decking of trailer transport system 1109. In some embodiments, trailer transport system 1109 may be part of a tractor-trailer combination for over road travel, a trailer modified to be transported on a flatbed railcar, portions thereof, combinations thereof, and/or the like.

FIG. 11B may illustrate a multi-pack example of loading and packing of a plurality of transporters 400 on a mobile platform 1109 (trailer transport system 1109). FIG. 11B shows a different loading/packing arrangement for the plurality of transporters 400 as compared to FIG. 11A, otherwise FIG. 11A and FIG. 11B are substantially similar. In some embodiments, a plurality of transporters 400 may be loaded and arranged inside a specialized and modified shipping container type trailer system 1101. In some embodiments, shipping container type trailer system 1101 may comprise a shipping container 1103. In some embodiments, shipping container 1103 may be reinforced by structural supports 1105. In some embodiments, structural supports 1105 may surround the body of shipping container 1103. In some embodiments, structural supports 1105 may crisscross the cavity of shipping container 1103, forming a polygonal lattice-like structure, that forms a shelving or racking system for receiving the plurality of transporters 400. In some embodiments, internally (and/or exteriorly) disposed in shipping container 1103 may be a protective layer 1107. In some embodiments, shipping container 1103 (with the plurality of transporters 400) may be loaded onto of decking of trailer transport system 1109.

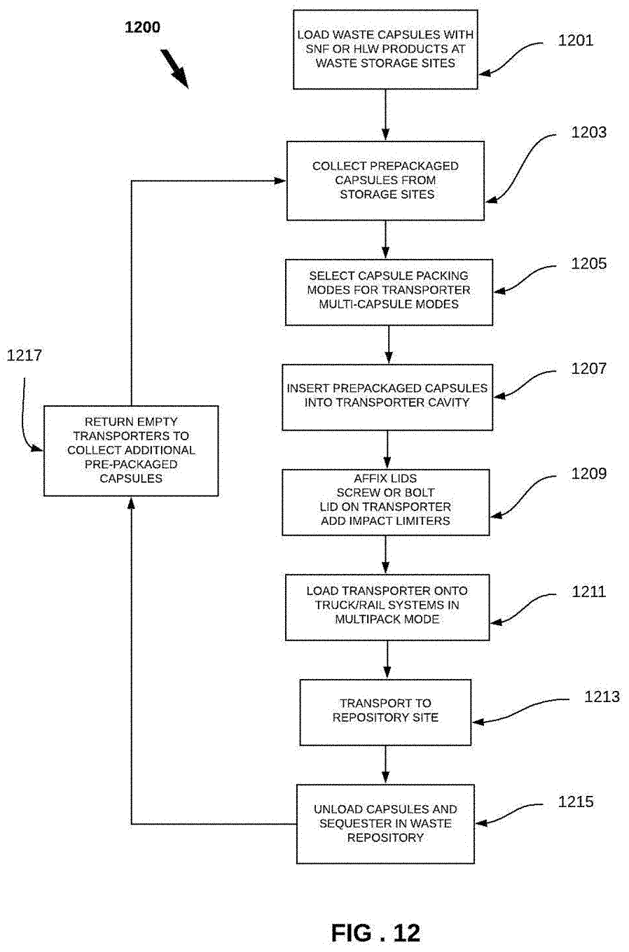

FIG. 12 may depict a flowchart of method 1200. FIG. 12 may depict at least some steps in method 1200. In some embodiments, method 1200 may be considered as illustrating operations involved in implementing the invention. In some embodiments, method 1200 may be a method of transporting HLW/SNL from one site (an intended temporary storage site) to another site (e.g., a final repository site), using transporter(s) 400. In some embodiments, method 1200 may be a method of prepackaging the waste-capsules 300 at remote storage sites with SNF and/or HLW, a method wherein the SNF (or HLW) is inserted into the waste-capsule(s) 300 which are then utilized to store the waste material permanently in geologically deep repositories or temporarily in other near surface locations; also a method of inserting these prepackaged waste-capsule(s) 300 into transporter(s) 400; also a method of transferring by road or rail transporter(s) 400 to a repository site; and finally of unloading and sequestering waste-capsule(s) 300 from the transporter(s) 400, so that now unloaded waste-capsule(s) 300 may be disposed in the final repository and the now empty transporter(s) 400 may be reused.

Continuing discussing FIG. 12, in some embodiments method 1200 may comprise steps: 1201, 1203, 1205, 1207, 1209, 1211, 1213, 1215, 1217, portions thereof, combinations thereof, and/or the like. Some of these steps may be mandatory, while other steps may be optional. Some steps may be done out of the order noted in FIG. 12.

Continuing discussing FIG. 12, in some embodiments, step 1201 may be a step of loading waste-capsule(s) 300 with: SNF assemblies 100, SNF, HLW, radioactive waste, radioactive material, portions thereof, combinations thereof, and/or the like. In some embodiments, step 1201 may be carried out at various locations where SNF assemblies 100, SNF, HLW, radioactive waste, radioactive material, portions thereof, combinations thereof, and/or the like are currently being stored, which may be sites that were originally intended only as temporary surface storage locations. In some embodiments, the loaded waste-capsule(s) 300 may be intended for final/long-term disposal in a final repository, which may be located deeply underground and/or away from the temporary surface storage sites. In some embodiments, step 1201 may occur at multiple sites across the country. In some embodiments, step 1201 may occur at or near the nuclear power plants. In some embodiments, waste-capsules 300 may be of different sizes (lengths and/or diameters) and of different geometries and of different amounts of SNF assemblies 100, SNF, HLW, radioactive waste, radioactive material, portions thereof, combinations thereof, and/or the like. In some embodiments, loading of at least one waste-capsule 300 (with its radioactive waste) may permit step 1201 to initiation of step 1203.

Continuing discussing FIG. 12, in some embodiments, step 1203 may be a step of collecting loaded waste-capsule(s) 300 from at least one storage site. In some embodiments, step 1203 may be carried out in a radiation shielded environment. In some embodiments, collection of at least one loaded waste-capsule(s) 300 may permit initiation of step 1205.

Continuing discussing FIG. 12, in some embodiments, step 1205 may be a step of selecting loaded waste-capsule(s) 300 loading configuration into at least one transporter 400. As discussed above, a single transporter may removably hold at least one loaded waste-capsule 300, but could also removably hold up to nine (9), twelve (12), or fifteen (15) loaded waste-capsules 300. In some embodiments, step 1205 may be a decision step that determines and/or selects an optimal packing mode that maximizes the capacity and/or efficiency of the total transportation process. In some embodiments, in step 1205, depending on the geometries of the loaded waste-capsules 300 and/or weight of the loaded waste-capsules 300, a multi-capsule packing mode may be selected that allows the largest number of loaded waste-capsules 300 to be transported inside a given/selected transporter 400. In some embodiments, completion of step 1205 for at least one transporter 400 may permit initiation of step 1207.

Continuing discussing FIG. 12, in some embodiments, step 1207 may be a step of inserting a fixed number of loaded waste-capsules 300 (at least one) into at least one transporter 400, according to the loading scheme/arrangement selected/determined from step 1205. In some embodiments, completion of step 1207 for at least one transporter 400 may permit initiation of step 1209.

Continuing discussing FIG. 12, in some embodiments, step 1209 may be a step of removably sealing/closing off that now loaded at least one transporter 400. In some embodiments, step 1209 may entail placement of radiation protective medial plate 703, end support plate 705, screw type end cap 711 or wedge type end cap 819, cover 709 (flange type cover 809 [with bolts 811] or screw type cover 815), and/or the like into and/or onto that at least one transporter 400, such that the waste-capsule(s) 300 located within cavity 407 of that at least one transporter 400 are now removably sealed inside. In some embodiments, step 1209 may be a step of removably attaching at least one impact limiter 1001 to a terminal end of the now sealed at least one transporter 400. In some embodiments, step 1209 may be a step of removably attaching two opposing impact limiters 1001 to the two opposing terminal ends of the now sealed at least one transporter 400. In some embodiments, completion of step 1209 may result in at least one transporter 400 ready for transport. In some embodiments, completion of step 1209 for at least one transporter 400 may initiate step 1211.

Continuing discussing FIG. 12, in some embodiments, step 1211 may be a step of loading the at least one transporter 400 from step 1209 into a shipping container 1103 and/or onto a trailer transport system 1109. In some embodiments, step 1211 may entail loading a plurality of transporters 400 from step 1209 into one or more shipping container 1103 and/or onto one or more trailer transport systems 1109. In some embodiments, step 1211 may be carried out with respect to optimizing loading quantity and/or loading efficiencies. In some embodiments, step 1211 may be another decision step that determines and/or selects the optimal multi-pack mode that optimizes the profile of the truck-trailer transport system 1109 based on the highway regulations for heights and lengths of trailers. In some embodiments, step 1211 may be another decision step that determines and/or selects the optimal multi-pack mode that optimizes the profile of the rail transport system 1109 based on rail regulations for heights and lengths of trailers. In some embodiments, in step 1211, depending on the geometries of the multi-pack mode, the multi-packing mode may be selected that allows the tractor-trailer combination to travel freely on the roadways without violating height and distance regulations. In some embodiments, a same type of multi-pack selection process may be made for rail transportation modes to optimize transportation of transporter(s) 400. In some embodiments, completion of step 1211 for at least one shipping container 1103 and/or for at least one trailer transport system 1109 may permit initiation of step 1213.

Continuing discussing FIG. 12, in some embodiments, step 1213 may be a step of transporting the transporter(s) 400, via the at least one shipping container 1103 and/or the at least one trailer transport system 1109. In some embodiments, step 1213 may result in at least one loaded transporter 400 arriving at a destination location. In some embodiments, the destination location may be final repository location (or the above ground staging area for that final repository location which itself may be located deeply underground). In some embodiments, completion of step 1213 for at least one transporter 400 may permit initiation of step 1215.

Continuing discussing FIG. 12, in some embodiments, step 1215 may be a step of unloading and removing any waste-capsule(s) 300 from the arrived at least one transporter 400. In some embodiments, step 1215 may entail removal of: cover 709 (flange type cover 809 [with bolts 811] or screw type cover 815), screw type end cap 711 or wedge type end cap 819, end support plate 705, placement of radiation protective medial plate 703, and then any waste-capsule(s) 300 located inside cavity 407. In some embodiments, these now unloaded waste-capsule(s) 300 may be deposited into the final repository. In some embodiments, when at least one transporter 400 is now empty of its waste-capsule(s) 300, step 1217 may proceed.

Continuing discussing FIG. 12, in some embodiments, step 1217 may be a step of reusing and/or returning now empty transporter(s) 400 for subsequent transportation operations. In some embodiments, in step 1217, now empty transporter(s) 400 may be returned to SNF/HLW sites for reloading of waste-capsule(s) 300. In some embodiments, step 1217 may proceed back to step 1203.

In some embodiments, any mating (physically touching) surfaces shown and/or described herein, including, but not limited to, threaded connections, may further comprise use of adhesives and/or sealants.

Waste-capsules, transporters, impact limiters, packing configurations, loading configurations, shipping configurations, parts thereof, components thereof, devices thereof, apparatuses thereof, systems thereof, means thereof, and methods thereof—all with respect to objectives of the safe, efficient, and affordable transport of radioactive materials—have been described. The foregoing description of the various embodiments of the invention has been presented for the purposes of illustration and disclosure. It is not intended to be exhaustive or to limit the invention to the precise form disclosed. Many modifications and variations are possible in light of the above teaching without departing from the spirit of the invention.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A transporter configured for removably housing radioactive material and configured for safely containing the removably housed radioactive material during transportation operations of the transporter, wherein the transporter comprises:
at least four layers, namely, an outermost structural-jacket, an innermost liner, a containment layer and a radiation shielding layer, wherein the radiation shielding layer is configured to absorb at least some radiation emitted from the radioactive material when the radioactive material is removably within an inner cavity of the transporter;
wherein the transporter is a linearly elongate member with two opposing terminal ends and with a center axis that is centered with respect to a transverse-width cross-section of the transporter and wherein the center axis runs in a direction that is parallel with an overall length of the transporter; wherein with respect to the at least four layers, the innermost liner is closest to the center axis and the outermost structural jacket is furthest away from the center axis;
wherein the containment layer and the radiation shielding layer are disposed between the outermost structural-jacket and the innermost liner;
wherein the innermost layer surrounds the inner cavity, wherein the inner cavity is configured to removably receive the radioactive material;
wherein the inner cavity is accessible from at least one terminal end selected from the two opposing terminal ends of the transporter;
wherein the at least one terminal end is removably closeable via use of closure means.

2. The transporter according to claim 1, wherein the at least four layers are arranged substantially concentrically about the center axis.

3. The transporter according to claim 1, wherein the radioactive material is selected from at least one spent nuclear fuel assembly or portion thereof.

4. The transporter according to claim 1, wherein the radioactive material is loaded and sealed into at least one waste-capsule and the at least one waste-capsule is removably loaded into the inner cavity from the at least one terminal end.

5. The transporter according to claim 1, wherein the outermost structural jacket provides a majority of rigidity and structural support for the transporter with the radioactive material.

6. The transporter according to claim 1, wherein the outermost structural jacket is constructed mostly of steel or a steel alloy, wherein the steel and the steel alloy are not stainless steel.

7. The transporter according to claim 1, wherein the outermost structural-jacket, before an impact, has a yield strength of at least 150,000 pounds per square inch while having a wall thickness of two and one-quarter (2.25) inches or less.

8. The transporter according to claim 1, wherein the outermost structural jacket has an external diameter that is fixed, wherein the external diameter is selected from a range of eighteen (18) inches to thirty-six (36) inches, plus or minus one inch.

9. The transporter according to claim 1, wherein the containment layer is at least partially flexible, conformable, and/or deformable within predetermined limits.

10. The transporter according to claim 1, wherein the containment layer is configured to be unbreached after the outermost structural-jacket has been crushed in at least one location up to a predetermined limit.

11. The transporter according to claim 1, wherein when the at least one terminal end is removably closed, the containment layer completely surrounds the innermost liner and the inner cavity.

12. The transporter according to claim 1, wherein the containment layer is mostly constructed of one or more of: polyethylene, low-density polyethylene, linear low-density polyethylene, high-density polyethylene, nylon, polyethylene terephthalate, polyethylene terephthalate polyester, polytrimethylene terephthalate, polybutylene terephthalate, polypropylene, polyvinyl chloride, polyamide, polystyrene, ethylene vinyl acetate, ethylene methyl acrylate, ethylene vinyl alcohol, polytetrafluoroethylene, perfluoroalkoxy alkane, fluorinated ethylene propylene, silicone, synthetic rubber, or natural rubber.

13. The transporter according to claim 1, wherein the containment layer has a fixed resting wall thickness, wherein the resting wall thickness is selected from a range of one and one half (1.5) inches to three (3) inches thick, plus or minus one-half (0.5) inch.

14. The transporter according to claim 1, wherein the containment layer has two main parts, namely, a cylindrical wall member and at least one end cap, wherein the at least one end cap is removably attachable to a terminal end of the cylindrical wall member, wherein the at least one end cap is at least a component of the closure means.

15. The transporter according to claim 1, wherein at least some of an exterior of the containment layer is in physical communication with at least some of interior surfaces of the outermost structural-jacket.

16. The transporter according to claim 1, wherein at least some of an exterior of the containment layer is attached to at least some of interior surfaces of the outermost structural-jacket.

17. The transporter according to claim 1, wherein embedded within the containment layer are a plurality of magnetic strips that are configured to magnetically attach the containment layer to the outermost structural-jacket.

18. The transporter according to claim 1, wherein the containment layer is a plurality of layers.

19. The transporter according to claim 1, wherein the radiation shielding layer is selected from one or more of: a gamma radiation shield configured to absorb at least some gamma radiation emissions, a neutron radiation shield configured to absorb at least some neutron emissions, or a composite metal foam configured to absorb at least some radiation.

20. The transporter according to claim 1, wherein the radiation shielding layer is disposed between the innermost liner and the containment layer.

21. The transporter according to claim 1, wherein the radiation shielding layer is disposed between the outermost structural jacket and the containment layer.

22. The transporter according to claim 1, wherein the innermost liner is made mostly from steel or a steel alloy and has a wall thickness that is fixed, wherein the wall thickness is selected from a range of one-quarter (0.25) to one-half (0.5) inches thick, plus or minus one-tenth of an inch.

23. The transporter according to claim 1, wherein the innermost liner has two main parts, namely, a cylindrical wall member and at least one end cap, wherein the at least one end cap is removably attachable to a terminal end of the cylindrical wall member, wherein the at least one end cap is at least a component of the closure means.

24. The transporter according to claim 1, wherein the transporter further comprises at least one impact limiter, wherein the at least one impact limiter is removably attached to an exterior of the at least one terminal end, wherein the at least one impact limiter is configured to absorb some impacts and to protect the transporter from impacts of a predetermined limit.

25. The transporter according to claim 24, wherein the at least one impact limiter has a substantially spherical outer shell with an outer diameter that is larger than an external diameter of the outermost structural-jacket.

26. The transporter according to claim 1, wherein the transporter further comprises the closure means,
wherein the closure means comprises at least: a cover, an end cap, an end support plate, and a radiation protective media plate;
wherein the radiation protective media plate is configured to absorb at least some emitted radiation from the radioactive material that is removably housed within the inner cavity, wherein the radiation protective media plate butts up against a terminal end portion of at least one waste-capsule removably housed within the inner cavity, wherein the at least one waste-capsule houses the radioactive material;
wherein the end support plate is a removable component of the innermost liner;
wherein the end cap is a removable component of the containment layer and the end cap is removably attachable to a cylindrical wall portion of the containment layer;
wherein the cover is a removable component of the outermost structural jacket and the cover is removably attachable to a cylindrical wall portion of the outermost structural-jacket; and
wherein with respect to the direction that is parallel with the center axis, the end support plate is disposed between the radiation protective media plate and the end cap, and the end cap is disposed between end support plate and the cover.
